(19) United States
(12) Patent Application Publication
(10) Pub. No.: US 2009/0233217 A1
(43) Pub. Date: Sep. 17, 2009

(54) TONER, IMAGE FORMING METHOD, AND PROCESS CARTRIDGE

(76) Inventor: Kumi HASEGAWA, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/405,531

(22) Filed: Mar. 17, 2009

(30) Foreign Application Priority Data
Mar. 17, 2008 (JP) 2008-067396

(51) Int. Cl. G03G 13/20; G03G 9/00; G03G 21/16

(52) U.S. Cl. 430/124.3; 430/108.3; 430/124.1; 399/111

(57) ABSTRACT

A toner is provided that includes a binder resin which is selected from (a) a polyester resin, (b) a hybrid resin comprising a polyester unit and a vinyl copolymer unit, and (c) a mixture of a polyester resin and a hybrid resin, a colorant, a release agent, and at least one of an aluminum compound and a zirconium compound of an aromatic oxycarboxylic acid. The toner has a 1/2 flow starting temperature of from 120 to 130° C. measured by a flow tester, and a storage elastic modulus (G′) of from 50,000 to 200,000 Pa and a tan δ(G″/G′) that is a ratio of a loss elastic modulus (G″) to a storage elastic modulus (G′) of from 1.0 to 3.0 at a frequency of 10 Hz, a temperature of 100° C., and a stress of 2,000 Pa.

### BACKGROUND OF THE INVENTION

1. Field of the Invention

The present invention relates to a toner for use in electrophotography. In addition, the present invention also relates to an image forming method and a process cartridge using the toner.

2. Discussion of the Background

In electrophotography, toner images are generally fixed on a recording medium by heat rollers. In accordance with increasing momentum toward energy saving, toners have been developed to be fixable at low temperatures (such toners are hereinafter referred to as low-temperature fixable toners), which is a strong demand especially from medium to high speed copiers. In response to such demand, polyester resins are used for toners recently because of their good low-temperature fixability and heat resistant storage stability as compared to the styrene acrylic resins conventionally used. To further improve low-temperature fixability, thermal properties of such resins need to be controlled. However, if the glass transition temperature is reduced too much, heat resistant storage stability may deteriorate. If the molecular weight is reduced too much, hot offset may occur at lower temperatures. The “hot offset” here refers to an undesirable phenomenon in which part of a fused toner image is adhered to the surface of a heat member and re-transferred onto an undesired portion of a recording medium.

On the other hand, fixing methods have been also developed to fix toners at much lower temperatures. For example, warm-up time of an image forming apparatus has been shortened so that energy consumption is reduced as much as possible. One proposed approach for shortening warm-up time involves lowering the heat capacity of fixing members such as heat rollers so that toners are more responsive to temperature. This approach may be achieved by thinning the fixing members or using materials with higher thermal conductivity for the fixing members. However, in these cases, such fixing members may be deformed upon application of pressure, which may avoid application of proper pressure in fixing.

Another proposed approach involves using belts in place of rollers for the fixing members. Belts generally have lower thermal capacity and are capable of widening fixing nip and preheating toner images, resulting in fixing of toners at low temperatures. However, belts have a disadvantage of easily bending or edging up, which may also avoid application of proper pressure in fixing.

In a case in which the fixing pressure is low, toners are required to be deformed at much lower temperatures because the toner cannot receive sufficient pressure for deformation. However, it is apparent that these low-temperature fixable toners may easily cause hot offset.

To prevent the occurrence of hot offset, release agents such as waxes are generally included in toners. The release agent forms domains thereof in a toner and exudes therefrom at the time the toner is fixed on a recording medium. If a large number of domains exist on the surface region of toner particles, some problems may arise such as deterioration of storage stability and developability of the toner. Alternatively, if the fixing pressure is low, the release agent is difficult to exude. An ideal existential state of domains in toner is hard to be achieved.

Unexamined Japanese Patent Application Publication Nos. (hereinafter JP-A) 07-295290, 08-234480, and 09-034163 disclose toners, the viscoelasticity of each of which is controlled so that both low-temperature fixability and hot offset resistance are satisfied without causing any side effect by waxes. However, low-temperature fixabilities thereof are still insufficient.

Japanese Patent No. (hereinafter JP) 2904520 and JP-A 2000-056511 disclose toners which are fixable both with low pressures and at low temperatures. However, these toners may not be fixable at low temperatures when using fixing systems having a shorter warm up time. Further, if the toner is used for full-color image formation, the toner should be designed in consideration of gloss and color reproducibility as well as low-temperature fixability.

JP3342272 discloses a toner for full-color image formation in which the binder resin is prepared using a specific monomer, the colorant has a specific dispersion state, and thermal properties thereof are specified. Since this toner is designed not to include any release agent, gloss and color reproducibility may deteriorate if a release agent is simply introduced into this toner.

JP-A 2004-326075 discloses a toner for full-color image formation which includes a release agent. This toner has relatively good chargeability and fixability, however, it is designed in consideration of neither gloss nor color reproducibility. Further, this toner may not have resistance to mechanical stress which may be applied in a narrow developing gap, possibly causing toner scattering and fogging. Developing gaps are narrowing recently in accordance with recent demands for high-grade images.

JP 3957037 discloses a toner having specific rheologic properties. Although having a wide fixable temperature range, color reproducibility is not considered. It is presumed that this toner may not express high gloss because the binder resins form a sea-island structure therein, i.e., the binder resins are incompatible.

### SUMMARY OF THE INVENTION

Accordingly, an object of the present invention is to provide a toner preferably used for full-color image formation which provides low-temperature fixability, hot offset resistance, mechanical stress resistance, color reproducibility, and high gloss.

These and other objects of the present invention, either individually or in combinations thereof, as hereinafter will become more readily apparent can be attained by a toner, comprising:

a binder resin selected from the group consisting of (a) a polyester resin, (b) a hybrid resin comprising a polyester unit and a vinyl copolymer unit, and (c) a mixture of a polyester resin and a hybrid resin;

a colorant;

a release agent; and

at least one of an aluminum compound and a zirconium compound of an aromatic oxycarboxylic acid;

wherein the toner has a 1/2 flow starting temperature of from 120 to 130° C. measured by a flow tester, and wherein the toner has a storage elastic modulus (G′) of from 50,000 to 200,000 Pa and a tan δ(G″/G′) that is a ratio of a loss elastic modulus (G″) to a storage elastic modulus (G′) of from 1.0 to 3.0 at a frequency of 10 Hz, a temperature of 100° C., and a stress of 2,000 Pa;

and an image forming method and a process cartridge using the above toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of a fixing device for use in an image forming method of the present invention;

FIG. 2 is a schematic view illustrating another embodiment of a fixing device for use in an image forming method of the present invention;

FIG. 3 is an example flow curve obtained by a flow tester CFT-500;

FIG. 4 is a schematic view illustrating an embodiment of an image forming apparatus for use in an image forming method of the present invention;

FIG. 5 is a schematic view illustrating another embodiment of an image forming apparatus for use in an image forming method of the present invention which is a tandem full-color image forming apparatus employing an intermediate transfer medium;

FIG. 6 is a magnified schematic view illustrating an embodiment of the developing device 5C illustrated in FIG. 5;

FIG. 7 is a schematic view illustrating an embodiment of a swirling airflow classifier;

FIG. 8 shows example images with sharpness ranks 1, 3, and 5; and

FIG. 9 is a schematic view illustrating an embodiment of a charge quantity measuring instrument.

### DETAILED DESCRIPTION OF THE INVENTION

Generally, the present invention provides a toner which comprises a binder resin having a polyester unit and a charge controlling agent which is a metal compound of an aromatic oxycarboxylic acid. The toner has a 1/2 flow starting temperature of from 120 to 130° C. measured by a flow tester, and a specific storage elastic modulus (G′) and a specific tan δ that is a ratio of a loss elastic modulus (G″) to a storage elastic modulus (G′) at a frequency of 10 Hz, a temperature of 100° C., and a stress of 2,000 Pa.

In order to provide both low-temperature fixability and hot offset resistance at the same time, the toner has a 1/2 flow starting temperature of from 120 to 130° C., preferably from 122 to 128° C., and more preferably from 124 to 126° C., measured by a flow tester. When the 1/2 flow start temperature is too low, hot offset resistance may be insufficient. When the 1/2 flow starting temperature is too high, low-temperature fixability, gloss, and color reproducibility may deteriorate.

In order to provide mechanical stress resistance, color reproducibility, and high gloss at the same time, the toner has a specific storage elastic modulus (G′) of from 50,000to 200,000 Pa, preferably from 80,000 to 160,000 Pa, and more preferably from 100,000 to 120,000 Pa, at a frequency of 10 Hz, a temperature of 100° C., and a stress of 2,000 Pa. This means that the elastic modulus decreases not only at low temperatures but also at small stresses, which provides mechanical stress resistance, color reproducibility, and high gloss at the same time. In addition, the tan δ that is a ratio of the loss elastic modulus (G″) to the storage elastic modulus (G′) is from 1.0 to 3.0, which further provides mechanical stress resistance, color reproducibility, and high gloss at the same time. When the storage elastic modulus (G′) at a frequency of 10 Hz, a temperature of 100° C., and a stress of 2,000 Pa is too small, mechanical stress resistance may be insufficient. In this case, the toner may aggregate in a developing device or may cause toner scattering or fogging in a narrow developing gap of about from 0.1 to 0.5 mm. When the storage elastic modulus (G′) at a frequency of 10 Hz, a temperature of 100° C., and a stress of 2,000 Pa is too large, color reproducibility and gloss may deteriorate. When the tan δ (G″/G′) is too small, the surface of a resultant image may be rough because the storage elastic modulus (G′) is too large, resulting in low gloss. When the δ (G″/G′) is too large, the toner may slightly adhere to a fixing member because the loss elastic modulus (G″) is too large.

In order that the toner has a 1/2 flow starting temperature of from 120 to 130° C. measured by a flow tester and a storage elastic modulus (G′) of from 50,000 to 200,000 Pa at a frequency of 10 Hz, a temperature of 100° C., and a stress of 2,000 Pa, the toner includes at least one aluminum and/or zirconium compound of an aromatic oxycarboxylic acid and a binder resin having a polyester unit. In this case, the aluminum and/or zirconium, which are the central metals of the aluminum and/or zirconium compounds of an aromatic oxycarboxylic acid, may electrically form metallic cross-linked molecular chains with hydroxyl and/or acid groups in the polyester unit upon application of thermal energy in a melt-kneading process in pulverization toner manufacturing methods or a polymerization process in polymerization toner manufacturing methods. As a consequence, desired rheologic properties may be obtained.

The aluminum and/or zirconium compounds of an aromatic oxycarboxylic acid may be prepared by reacting an aromatic oxycarboxylic acid with chlorides, sulfates, acetates, or nitrates of aluminum and/or zirconium. Alternatively, they may be prepared by reacting an aromatic oxycarboxylic acid with zirconium oxychloride and/or aluminum oxychloride. Specific examples of the aluminum and/or zirconium compounds include salts and coordination compounds of aluminum and/or zirconium, but are not limited thereto.

More specifically, preferred embodiments of the aluminum and/or zirconium compounds include, but are not limited to, zirconium compounds having the following formula (A) and aluminum compounds having the following formula (B):

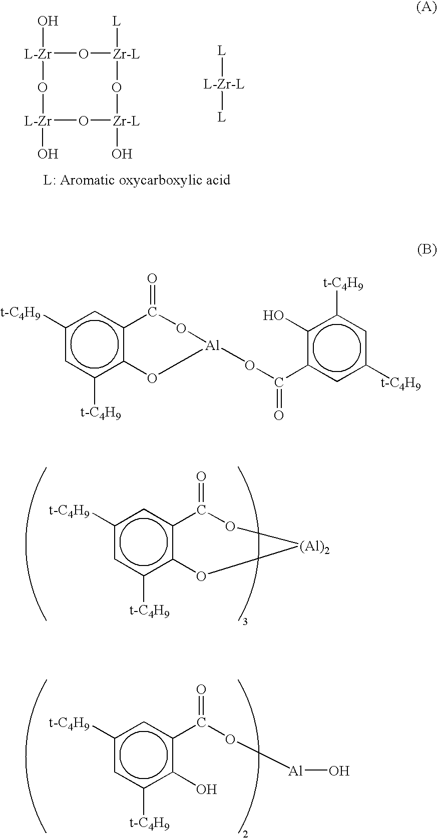

The electrically-formed metallic cross-linked molecular chains have lower elasticity compared to molecular chains formed in typical syntheses of resins. Accordingly, the toner has a 1/2 flow starting temperature of from 120 to 130° C. measured by a flow tester, and a storage elastic modulus (G′) of from 50,000 to 200,000 Pa and a tan δ (G″/G′) that is a ratio of a loss elastic modulus (G″) to a storage elastic modulus (G′) of from 1.0 to 3.0 at a frequency of 10 Hz, a temperature of 100° C., and a stress of 2,000 Pa.

When cross-linked molecular chains are formed by polycondensation of acids and alcohols, the resultant polyester may have a low acid value. Such a polyester may not anchor in paper, resulting in poor fixation. On the other hand, the metallic cross-linked molecular chains may be electrically formed without lowering the acid value of the resultant polyester. Accordingly, such a polyester may anchor in paper, resulting in good fixation.

If the molecular weight and cross-linking degree of the polyester are controlled so that the resultant toner has a ½ flow starting temperature of from 120 to 130° C. measured by a flow tester without including any aluminum and/or zirconium compound of an aromatic oxycarboxylic acid, the toner may have a storage elastic modulus (G′) of 200,000 Pa or more at a frequency of 10 Hz, a temperature of 100° C, and a stress of 2,000 Pa. This is because high elasticity may generate due to twisting of long molecular chains even if cross-linked components are not produced, or rubber elasticity may generate in a case in which cross-linked components are produced. As a consequence, good color reproducibility and high gloss may not be provided.

On the other hand, a toner in which the aluminum and/or zirconium, which are the central metals of the aluminum and/or zirconium compounds of an aromatic oxycarboxylic acid, electrically form metallic cross-linked molecular chains with hydroxyl and/or acid groups in the polyester unit and which has a 1/2 flow starting temperature of from 120 to 130° C. measured by a flow tester, generates neither high elasticity nor rubber elasticity. Accordingly, such a toner has a small elastic modulus even at a small stress, resulting in a storage elastic modulus (G′) of from 50,000 to 200,000 Pa and a δ (G″/G′) that is a ratio of a loss elastic modulus (G″) to a storage elastic modulus (G′) of from 1.0 to 3.0 at a frequency of 10 Hz, a temperature of 100° C., and a stress of 2,000 Pa.

Such a toner provides low-temperature fixability, hot offset resistance, mechanical stress resistance, good color reproducibility, and high gloss at the same time. In order to electrically form metallic cross-linked molecular chains, the use of at least one aluminum and/or zirconium compound of an aromatic oxycarboxylic acid is effective. This is because the central metal of the aluminum and/or zirconium compound and the aromatic oxycarboxylic acid largely polarizes, which is effective for electrically forming metallic cross-linked molecular chains.

Compounds other than aromatic oxycarboxylic acids may not largely polarize. In addition, compounds other than aluminum and/or zirconium compounds, such as zinc compounds and chromium compounds, may not largely polarize. Accordingly, these compounds are not effective for electrically forming metallic cross-linked molecular chains.

Suitable binder resins include a polyester unit. Although having an acid value, polyol, polyamide, and styrene resins may not electrically form metallic cross-linked molecular chains because the polarities thereof are small. Accordingly, a combination of aluminum and/or zirconium compounds of an aromatic oxycarboxylic acid and a binder resin having a polyester unit is effective to electrically form metallic cross-linked molecular chains upon application of thermal energy in a melt-kneading process in pulverization toner manufacturing methods or a polymerization process in polymerization toner manufacturing methods.

Suitable binder resins preferably have a 1/2 flow starting temperature of from 95 to 115° C., more preferably from 100 to 110, measured by a flow tester. Such binder resins may electrically form metallic cross-linked molecular chains with aluminum and/or zirconium compounds of an aromatic oxycarboxylic acid when being melt-kneaded with other toner components or being subjected to polymerization so that the molecular weight thereof increases. Accordingly, the resultant toner has a 1/2 flow starting temperature of from 120 to 130° C. measured by a flow tester, and a storage elastic modulus (G′) of from 50,000 to 200,000 Pa and a δ (G″/G′) that is a ratio of a loss elastic modulus (G″) to a storage elastic modulus (G′) of from 1.0 to 3.0 at a frequency of 10 Hz, a temperature of 100° C., and a stress of 2,000 Pa.

The amount of generation of electrical cross-linking is indicated by the 1/2 flow starting temperature, and that may be controlled by varying the amount of thermal energy, the acid value and hydroxyl value of binder resins, and/or the amount of aluminum and/or zirconium compounds of an aromatic oxycarboxylic acid. When the amount of aluminum and/or zirconium compounds of an aromatic oxycarboxylic acid is too large, the storage elastic modulus (G′) may be too large or the δ (G″/G′) that is a ratio of a loss elastic modulus (G″) to a storage elastic modulus (G′) may be too small at a frequency of 10 Hz, a temperature of 100° C., and a stress of 2,000 Pa, even if the 1/2 flow starting temperature is from 120 to 130° C. Accordingly, preferable amounts of aluminum and/or zirconium compounds of an aromatic oxycarboxylic acid are from 0.5 to 5.0% by weight. In order to serve as a negative charge controlling agent, preferable amounts of aluminum and/or zirconium compounds of an aromatic oxycarboxylic acid are from 1.0 to 5.0% by weight.

As described above, suitable binder resins preferably have a 1/2 flow starting temperature of from 95 to 115° C. measured by a flow tester. Suitable binder resins include both single resins and combinations of multiple resins. For example, a suitable binder resin may be a powder mixture of 90 parts by weight of a polyester resin having a 1/2 flow starting temperature of 100° C. and 10 parts by weight of a hybrid resin including a polyester unit and a vinyl copolymer unit and having a 1/2 flow starting temperature of 120° C. In this case, the powder mixture preferably has a 1/2 flow starting temperature of from 95 to 115° C. measured by a flow tester.

When the 1/2 flow starting temperature of a binder resin exceeds 115° C., the elasticity of the binder resin is too high. Therefore, the amount of aluminum and/or zirconium compounds of an aromatic oxycarboxylic acid should be decreased in order to obtain the desired rheologic properties, which may decrease negative chargeability of the toner as well. When the 1/2 flow starting temperature of a binder resin exceeds 120° C., the storage elastic modulus (G′) may be too large even when the 1/2 flow starting temperature of the toner is from 120 to 130° C., resulting in deterioration of color reproducibility and gloss. When the 1/2 flow starting temperature of a binder resin is below 95° C., the glass transition temperature of the binder resin decreases even when the 1/2 flow starting temperature of the toner is from 120 to 130° C., resulting in deterioration of storage stability of the toner.

As described above, a toner according to the present invention, that includes one or more aluminum and/or zirconium compounds of an aromatic oxycarboxylic acid and a binder resin having a polyester unit has proper rheologic properties so that low-temperature fixability, hot offset resistance, mechanical stress resistance, good color reproducibility, and high gloss are provided at the same time. When such a toner is prepared by a pulverization method and further includes a wax as a release agent, a melt-kneaded mixture of toner components may be pulverized at the wax portions. As a consequence, the wax tends to present on the surfaces of the resultant toner particles, degrading fluidity and requiring a large amount of external additives. For this reason, the binder resin preferably includes a hybrid resin which has a polyester unit and a vinyl copolymer unit.

In a case in which a toner includes a hybrid resin having a polyester unit and a vinyl copolymer unit, a melt-kneaded mixture of toner components may be pulverized at the vinyl copolymer portions. As a consequence, the vinyl copolymer, not the wax, tends to present on the surfaces of the resultant toner particles, improving fluidity and reducing the amount of external additives needed. Similarly, when a polyester resin and a vinyl copolymer resin are provided separately, not in the form of a hybrid resin, a melt-kneaded mixture of toner components may be pulverized at the vinyl copolymer portions. However, the polyester and vinyl copolymer resins may be incompatible and may form a sea-island structure, degrading color reproducibility.

Accordingly, a toner of the present invention comprises a colorant, a release agent, one or more aluminum and/or zirconium compounds of an aromatic oxycarboxylic acid, and a binder resin having a polyester unit which is selected from (a) a polyester resin, (b) a hybrid resin having a polyester unit and a vinyl copolymer unit, and (c) a mixture of a polyester resin and a hybrid resin, and has a 1/2 flow starting temperature of from 120 to 130° C. measured by a flow tester, and a storage elastic modulus (G′) of from 50,000 to 200,000 Pa and a δ (G″/G′) that is a ratio of a loss elastic modulus (G″) to a storage elastic modulus (G′) of from 1.0 to 3.0 at a frequency of 10 Hz, a temperature of 100° C., and a stress of 2,000 Pa, thereby providing low-temperature fixability, hot offset resistance, mechanical stress resistance, good color reproducibility, high gloss, and high fluidity at the same time.

Suitable polyester resins are preferably synthesized using a catalyst selected from tin (II) oxides and tin compounds having the following formula (C):

(RCOO)₂Sn (C)

wherein R represents an alkyl or alkenyl group having 5 to 19 carbon atoms.

Among these tin compounds, tin (II) octylate, tin (II) dioctanoate, tin (II) distearate, and tin (II) oxide are preferable.

A polyester resin may be prepared by subjecting a divalent alcohol and a dicarboxylic acid to condensation polymerization in the presence of the catalyst described above in an inert gas atmosphere at a temperature of from 180 to 250° C., and under reduced pressures, if needed. The catalyst may remain in the resultant polyester resin. Such a polyester resin composition in which catalyst remain may be preferably used as the binder resin as well.

Polyester resins useful for the present invention preferably have a 1/2 flow starting temperature of from 90 to 115° C., and more preferably from 100 to 110° C., measured by a flow tester. When the 1/2 flow starting temperature is too low, the resin may have a weight average molecular weight of from 30,000 to 50,000, which is relatively low. Such low-molecular-weight resins generally have a large number of end groups. This means that reactive sites which electrically form metallic cross-linking with aluminum and/or zirconium compounds of an aromatic oxycarboxylic acid are large in number. In such a case, it is preferable that each of the reactive sites react equally. When the reactions are not equally performed among the reactive sites, the resultant toner may express a high reflective index when being melted, resulting in low gloss images.

The tin compounds having the formula (C) react more slowly (in other words, have lower reactivity), compared to dibutyltin oxides and dibutyltin acetates which are generally used in industrial fields. Since dibutyltin oxides and dibutyltin acetates react quickly, in other words, have higher reactivity, there actions tend to be performed unequally. As a consequence, the resultant toner may express a high reflective index when being melted, resulting in low gloss images. The reactions tend to be performed unequally especially when the reactions proceed quickly in an initial stage. Therefore, in order that the reactions proceed equally, the amount of the tin compound may be reduced or the reaction temperature may be decreased in the initial stage so that the reactions proceed slowly. However, the slower the reaction speed, the longer the reaction time. Such a longer reaction time may cause coloring of the resultant resin, which is disadvantageous for full-color toners.

When the number of carbon atoms in R in the formula (C) is less than 5 or greater than 19, the reactivity decreases. As a result, the reaction time is lengthened and the resultant resin is colored, thereby degrading color reproducibility. Since the tin compounds having formula (C) and tin oxides (II) may have proper reactivity throughout the reaction, they are capable of producing transparent resins.

The tin compounds are added in an amount of from 0.2 to 1.0% by weight, preferably from 0.4 to 0.8% by weight, based on polyester resins. When the amount is too small, the reactivity may deteriorate and the reaction time maybe lengthened, thereby coloring the resultant resin. When the amount is too large, the reactivity may increase too much. As a result, molecular chains cannot elongate and the reaction may be terminated. This results in ultra-short molecular chains having an ultra-low glass transition temperature, which may degrade storage stability. Because of having stable reactivity, the tin compounds having the formula (C) are capable of producing a toner having high transparency and storage stability.

From the viewpoint of electrical metallic cross-linking ability, specific preferred examples of usable aromatic oxycarboxylic acids include, but are not limited to, compounds having the following formula (1):

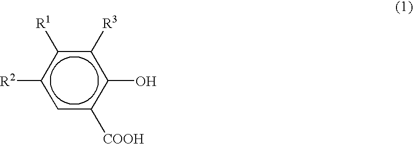

wherein each of R¹, R², and R³ independently represents a monovalent group, wherein R′ may share bond connectivity with R² or R³ to form an aromatic ring or a condensed ring.

Specific examples of the monovalent groups include, but are not limited to, hydrogen atom, halogen atom, hydroxyl group, and monovalent organic groups.

Specific examples of the halogen atoms include, but are not limited to, fluorine atom and chlorine atom.

Specific examples of the monovalent organic groups include, but are not limited to, carboxyl group, substituted or unsubstituted alkoxycarbonyl groups having 2 to 11 carbon atoms, substituted or unsubstituted alkoxy groups having 1 to 10 carbon atoms, substituted or unsubstituted alkyl and alkenyl groups having 1 to 10 carbon atoms, and substituted or unsubstituted aryl groups having 6 to 18 carbon atoms.

Specific examples of the substituted or unsubstituted alkyl groups having 1 to 10 carbon atoms include, but are not limited to, methyl group, ethyl group, propyl group, and butyl group.

Specific examples of the substituted or unsubstituted aryl groups having 6 to 18 carbon atoms include, but are not limited to, phenyl group and naphthyl group.

Among these groups, hydrogen atom, chlorine atom, hydroxyl group, carboxyl group, and lower alkyl groups having 1 to 10 carbon atoms are preferable.

Specifically, the following aromatic oxycarboxylic acids having the formulae (2) to (9) are preferable from the viewpoint of charge giving ability:

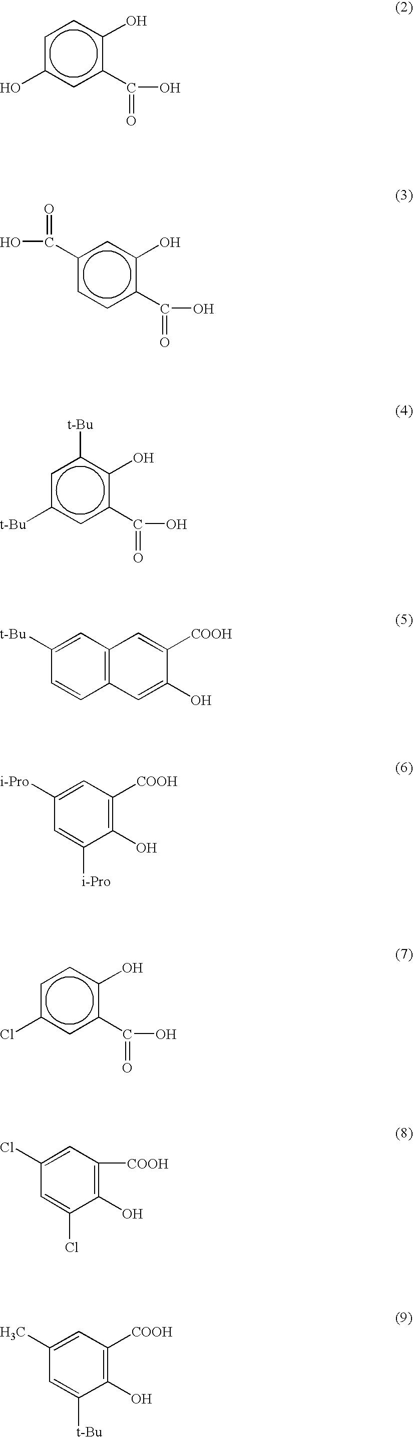

More specifically, 3,5-di-t-butyl salicylic acid is most preferable because it can electrically form metallic cross-linking, thereby providing negatively-chargeable toners.

The toner preferably has a weight average particle diameter of from 3.0 to 5.0 μm measured by a Coulter method (to be described in detail later) so that smooth images with high sharpness and granularity are produced. When the weight average particle diameter is too small, the toner particles may fall in concave portions in paper and may receive insufficient pressure from a fixing member. When the weight average particle diameter is too large, the sharpness and granularity of the resultant images may deteriorate.

THF (tetrahydrofuran)-soluble components of the toner preferably have a peak within a molecular weight range of from 2,500 to 6,000 in a chromatogram measured by GPC (gel permeation chromatography) using THF. Such a toner is preferably manufactured by pulverization methods because a melt-kneaded mixture of toner components thereof is easily pulverized at other than wax portions. In this case, mechanical stress resistance of the resultant toner may improve.

When the peak is below the range, the toner may include ultra-low-molecular-weight components, which easily cause hot offset. When the peak is above the range, low-temperature fixability of the toner may deteriorate. In addition, when the peak is above the range, a melt-kneaded mixture of toner components is too hard to pulverize. Therefore, the toner components may receive mechanical stress repeatedly in the process of being pulverized into particles having a weight average particle diameter of from 3.0 to 5.0 μm. As a consequence, wax easily bleeds from toner particles, and therefore the toner has a higher cohesiveness and a larger amount of an external additive is needed. Since mixing a large amount of external additive tends to generate free external additives, suitable methods of mixing external additives have to be carefully considered.

Since the toner thus obtained has a low elasticity, high gloss and good color reproducibility may be provided without preparing a colorant master batch.

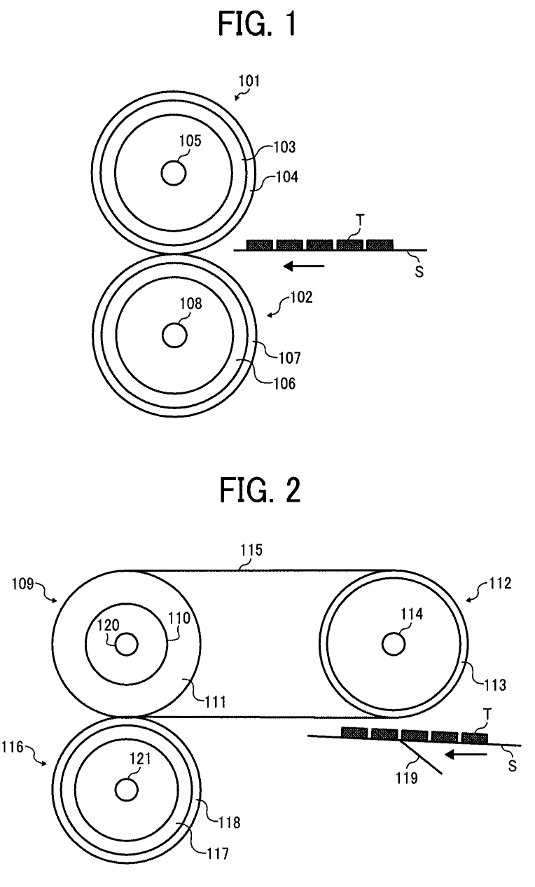

FIG. 1 is a schematic view illustrating an embodiment of a fixing device for use in an image forming method of the present invention. The fixing device includes a fixing roller 101 and a pressing roller 102. The fixing roller 101 includes a hollow cylindrical cored bar 103 made of high-heat conductors such as aluminum, iron, stainless steels, and brass, the surface of which is covered with an offset prevention layer 104 made of materials such as RTV, silicone rubbers, tetrafluoroethylene-perfluoroalkyl vinyl ether (PFA), and polytetrafluoroethylene (PTFE). A heating lamp 105 is fixed inside the fixing roller 101. The pressing roller 102 includes a metallic cylinder 106, which may be made of the same material as the hollow cylindrical cored bar 103, the surface of which is covered with an offset prevention layer 107 made of materials such as PFA and PTFA. A heating lamp 108 may be fixed inside the pressing roller if needed. The fixing roller 101 and the pressing roller 102 are pressed against each other by springs while rotating. An image receiving sheet S having an unfixed toner image T thereon is passed between the fixing roller 101 and the pressing roller 102 so that the toner image T is fixed on the image receiving sheet S.

One preferred embodiment of the fixing roller 101 includes an inelastic roller having an offset prevention layer made of materials such as PTE, PFA, and FEP. Another preferred embodiment of the fixing roller 101 includes a metallic cylinder having a thickness of 1.0 mm or less, which may shorten the warm up time. A preferable thickness of the metallic cylinder is from 0.2 to 0.7 mm, but that depends on the strength and thermal conductivity of the material.

Generally, higher surface pressures of the fixing roller have advantage in strong fixation of toner images. However, the above-described metallic cylinder having a thickness of less than 1.0 mm may not be resistant to high pressures, which may cause deformation of the metallic cylinder. Accordingly, in such a case, the surface pressure of the fixing roller is preferably set to 1.5×10⁵ Pa or less, and more preferably from 0.5 to 1.0×10⁵ Pa. The surface pressure is calculated by dividing a load applied to both ends of a roller by the contact area of the roller. The contact area of a roller can be measured as follows. First, a sheet, such as an OHP sheet, the surface condition of which is largely changed by application of heat, is passed through between rollers heated to a temperature at which toner images are fixable. The sheet is stopped moving for 10 seconds so that the surface condition is changed, and evacuated thereafter. The area of surface-changed portion is equivalent to the contact area.

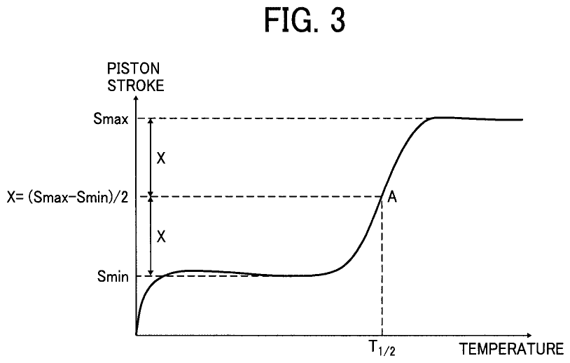

FIG. 2 is a schematic view illustrating another embodiment of a fixing device for use in an image forming method of the present invention. A fixing roller 109 includes a metallic cored bar 110 made of materials such as aluminum and iron, the surface of which is covered with an elastic body 111 such as silicone rubbers. A heating roller 112 includes a hollow cylindrical metallic cored bar 113 made of materials such as aluminum, iron, copper, and stainless steels, and a heating lamp 114 fixed inside the hollow cylindrical metallic cored bar 113. A fixing belt 115 is stretched taut between the fixing roller 109 and the heating roller 112. The fixing belt 115 includes a substrate made of materials such as nickel and polyimide having a thickness of from 30 to 150 μm and an offset prevention layer made of materials such as silicone rubbers having a thickness of from 50 to 300 μm or fluorocarbon rubbers having a thickness of from 10 to 50 μm which is formed on the substrate. A pressing roller 116 includes a metallic coredbar 117, the surface of which is covered with and elastic body 118. The pressing roller 116 presses the fixing belt 115 against the fixing roller 109 from below so that a nip is formed between the fixing belt 115 and the pressing roller 116. A guide 119 is configured to support an image receiving sheet S having an unfixed toner image T thereon.

Heating lamps 120 and 121 may be optionally fixed inside the fixing roller 109 and the pressing roller 116, respectively.

Preferred embodiments of fixing devices are not limited to the embodiments described above.

The toner of the present invention may be used for both one-component developers and two-component developers. In both cases, the toner may be contained in a container, and the container containing the toner may be commercially distributed independently from image forming apparatuses. Specific examples of usable containers include widely-used bottles and cartridges, but are not limited thereto. Specific examples of the image forming apparatuses include apparatuses which form images by electrophotography such as copiers and printers, but are not limited thereto.

Rheologic properties such as the loss elastic modulus (G″) and storage elastic modulus (G′) of toners may be measured using an instrument RHEOSTRESS RS50 from HAAKE, using a parallel plate having a diameter of20 mm and setting the gap to 2 mm, the frequency to 10 Hz, and the temperature to 100° C., for example. The stress is variable from 1,000 to 3,000 Pa. The loss elastic modulus (G″) and storage elastic modulus (G′) of a toner are measured when the stress is 2,000 Pa. A toner is formed into a pellet having a diameter of 20 mm and a thickness of 2 mm.

The 1/2 flow starting temperature (T_{1/2}) of toners and resins may be measured using a flow tester CTF-500 from Shimadzu Corporation, using a die having a pore diameter of 0.5 mm and setting the pressure to 10 kgf/cm² (9.8×10⁵ Pa) and the heating temperature to 3° C./min. A sample is formed into a 1-cm² pellet.

FIG. 3 is an example flow curve obtained by the flow tester CFT-500. The X-axis represents temperature and the Y-axis represents piston stroke. As illustrated in FIG. 3, a value of a point A on the Y-axis is the midpoint between Smin corresponding to flow starting point and Smax corresponding to flow ending point. A value of the point A on the X-axis is defined as the 1/2 flow starting temperature (T_{1/2}).

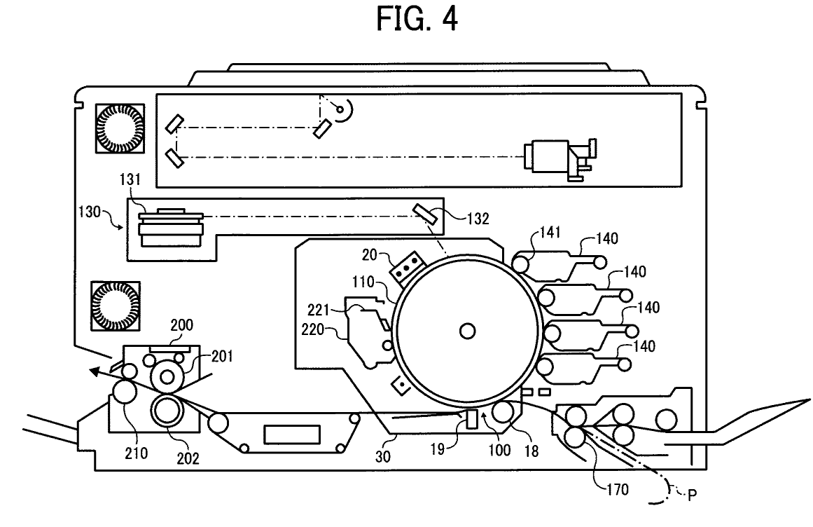

FIG. 4 is a schematic view illustrating an embodiment of an image forming apparatus for use in an image forming method of the present invention. A photoreceptor 100 serving as an image bearing member includes a conductive drum and an organic photosensitive layer and a resin layer formed on the conductive substrate in this order. The photoreceptor 100 is grounded and is driven to rotate clockwise. A scorotron charger 20 evenly charges the circumferential surface of the photoreceptor 100 by corona discharge. In advance of the corona discharge, an irradiator 110 such as light emitting diodes may neutralize the circumferential surface of the photoreceptor 100 so that previous latent images are removed therefrom.

After evenly charging the circumferential surface of the photoreceptor 100, an image irradiator 130 emits a light beam based on image signals. The image irradiator 130 includes a laser diode as a light source, not shown. The light beam is bent by a polygon mirror 131 that is rotating, an fθ lens, and a reflective mirror 132 so as to scan the photoreceptor 100, resulting in formation of an electrostatic latent image on the photoreceptor 100.

The electrostatic latent image is developed by developing devices 140 disposed along the circumferential surface of the photoreceptor 100. Each of the developing devices 140 contains yellow, magenta, cyan, and black toners, respectively, and a carrier. First, the electrostatic latent image is developed with the first-color developer which is borne on a developing sleeve 141. The developing sleeve 141 contains a magnet fixed inside thereof so as to bear developers while rotating. A developer layer forming member, not shown, forms a developer layer having a thickness of from 100 to 600 μm. The developer layer is conveyed to a developing area.

Typically, direct and/or alternating current bias voltage is applied between the photoreceptor 100 and the developing sleeve 141.

After the first-color toner image formation is completed, the scorotron charger 20 evenly charges the photoreceptor 100 again and the second-color latent image is formed by the image irradiator 130. The third-color and fourth-color latent images are sequentially formed on the photoreceptor 100 in the same way. As a result, toner images of four colors are sequentially formed on the photoreceptor 100.

A transfer medium P such as paper is fed to a transfer area by rotation of a paper feeding roller 170 in synchronization with an entry of the toner images to the transfer area. At the time a toner image is transferred onto the transfer medium P, a transfer roller 18 is pressed against the circumferential surface of the photoreceptor 100 so that the transfer medium P is sandwiched thereby.

The transfer medium P is then neutralized by a separation brush 19 which is pressed against the photoreceptor 100 nearly simultaneous with the transfer roller 18. As a consequence, the transfer medium P is separated from the photoreceptor 100 and conveyed to a fixing device 200. The toner image is fixed on the transfer medium P by application of heat from a heating roller 201 and pressure from a pressing roller 202. The transfer medium P having the toner image thereon is discharged from the image forming apparatus by rotation of a discharge roller 210. The transfer roller 18 and the separation brush 19 are evacuated from the surface of the photoreceptor 100 so as to prepare for the next image formation.

On the other hand, toner particles remaining on the photoreceptor 100 are removed by a blade 221 included in a cleaning device 220 which is pressed against the photoreceptor 100. The photoreceptor 100 is then neutralized by the irradiator 110 and charged by the scorotron charger 20 to form the next image. In a case in which multiple toner images are superimposed on the photoreceptor 100, the blade 221 is evacuated immediately after the surface of the photoreceptor 100 is cleaned.

A numeral 30 denotes a process cartridge including the photoreceptor 100, the charger 20, the transfer roller 18, the separation brush 19, and the cleaning device 220. Preferred embodiments of a process cartridge of the present invention are not limited to the process cartridge 30.

Such a process cartridge which integrally supports image forming members such as a photoreceptor, a developing device, a cleaning device, etc. may be detachably attachable to image forming apparatuses. Another embodiment of the process cartridge includes a photoreceptor and at least one of a charger, an image irradiator, a developing device, a transfer or separation device, and a cleaning device, and is detachably attachable to image forming apparatuses using a guide such as a rail member attached to the image forming apparatuses.

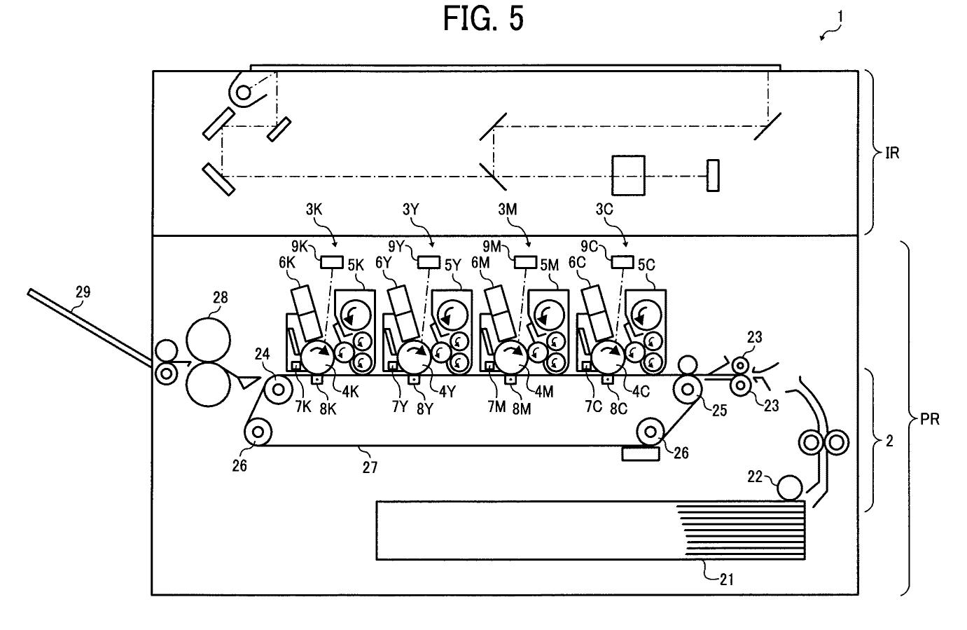

FIG. 5 is a schematic view illustrating another embodiment of an image forming apparatus for use in an image forming method of the present invention, which is a tandem full-color image forming apparatus employing an intermediate transfer medium.

In a typical tandem full-color image forming apparatus, independent image forming units corresponding to developing colors each including a photoreceptor, a developing device, a transfer device, etc., are arranged tandem along a paper feeding path. The image forming units almost simultaneously form toner images and each of the toner images is sequentially transferred and superimposed onto a sheet while the sheet is subjected to a series of paper feeding movements. Accordingly, tandem full-color image forming apparatuses can form images much faster than other types of full-color image forming apparatuses in which toner images are sequentially formed on a single photoreceptor.

The tandem full-color image forming apparatus illustrated in FIG. 5 includes an image reading part IR configured to read an original image and a printing part PR configured to print and reproduce the read image on a recording medium. In the image reading part IR, first, a CCD sensor reads optical information which is obtained from color separation of the original image into three primary colors of red, green, and blue. The image data thus obtained is then subjected to computation processing. The printing part PR includes a feeding part 2 configured to feed a recording medium and image forming units 3C, 3M, 3Y, and 3K configured to form cyan, magenta, yellow, and black images, respectively, on the recording medium.

The feeding part 2 includes a driving roller 24, a driven roller 25, tension rollers 26, and an endless conveyance belt 27 stretched taut across the rollers 24, 25, and 26. The conveyance belt 27 conveys the recording medium at a constant speed. On an upstream side from the conveyance belt 27, a feeding cassette 21 configured to store predetermined-sized sheets of the recording medium, a feeding roller 22 configured to feed the recording medium sheet by sheet from the feeding cassette 21, and timing rollers 23 configured to feed the sheet onto the conveyance belt 27 at a predetermined timing are disposed. On a downstream side from the conveyance belt 27, a fixing roller 28 configured to fix a transferred toner image on the recording medium and a discharge tray 29 configured to stack the sheets having images thereon are disposed. In addition, sensors are disposed both upstream and downstream sides from the conveyance belt 27 so as to detect timing for feeding sheets and paper jam.

The image forming units 3C, 3M, 3Y, and 3K form images by an electrostatic method, and include photoreceptors 4C, 4M, 4Y, and 4K, respectively, which are arranged above the conveyance belt 27 along a direction of feeding of the recording medium. Around the photo receptors 4C, 4M, 4Y, and 4K, developing devices 5C, 5M, 5Y, and 5K configured to develop electrostatic latent images formed on the photoreceptors 4C, 4M, 4Y, and 4K; chargers 6C, 6M, 6Y, and 6K configured to evenly charge the surfaces of the photoreceptors 4C, 4M, 4Y, and 4K; and cleaning devices 7C, 7M, 7Y, and 7K configured to remove developers remaining on the photoreceptors 4C, 4M, 4Y, and 4K are disposed, respectively. Besides, transfer chargers 8C, 8M, 8Y, and 8K configured to transfer toner images from the photoreceptors 4C, 4M, 4Y, and 4K onto the recording medium are disposed immediately below the photoreceptors 4C, 4M, 4Y, and 4K with the conveyance belt 27 therebetween.

On the other hand, a control part of a copier 1 does image processing such as shading correlation, density transformation, and edge enhancement based on optical information of red, green, and blue which are obtained in the image reading part IR so that image data of cyan, magenta, yellow, and black for writing electrostatic latent images are obtained. The image data for writing electrostatic latent images is temporarily stored in the control part.

Subsequently, light scanners 9C, 9M, 9Y, and 9K emit modulated light beams based on the image data of cyan, magenta, yellow, and black. The light beams scan the photoreceptors 4C, 4M, 4Y, and 4K which are rotating clockwise as indicated by arrows in FIG. 5, the surfaces of each of which has been evenly charged by the chargers 6C, 6M, 6Y, and 6K, respectively. As a result, electrostatic latent images are formed on the photoreceptors 4C, 4M, 4Y, and 4K. The electrostatic latent images are then developed by the developing devices 5C, 5M, 5Y, and 5K containing cyan, magenta, yellow, and black developers, respectively, to form toner images of cyan, magenta, yellow, and black. The toner images of cyan, magenta, yellow, and black are then sequentially transferred onto the recording medium fed from the feeding cassette 21 by the transfer chargers 8C, 8M, 8Y, and 8K, respectively, at facing points of the photoreceptor 4C, 4M, 4Y, and 4K and the conveyance belt 27. The recording medium on which the toner images of four colors are superimposed is fed to the fixing roller 28. The toner image is heated by the fixing roller 28 to melt and is fixed on the recording medium. The recording medium having the resultant full-color toner image thereon is discharged onto the discharge tray 29. Thus, an image formation for one sheet is completed.

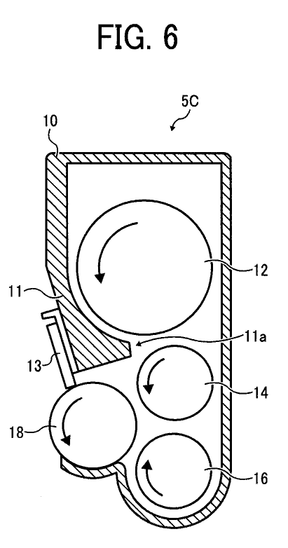

FIG. 6 is a magnified schematic view illustrating an embodiment of the developing device 5C illustrated in FIG. 5. Since the developing devices 5C, 5M, 5Y, and 5K have the same configurations, one of them will be explained as a representative referring to FIG. 6.

The developing device 5C includes a developer container 10 configured to contain a developer; and an agitation screw 12, a supply screw 14, and a collection screw 16 arranged in parallel. Each of the agitation screw 12, the supply screw 14, and the collection screw 16 includes a rotatable shaft equipped with multiple oblique blades. The rotatable shafts are connected with gears outside the developer container 10 and are driven to rotate by a driving device such as a motor. A developer is fed by rotations of the screws 12, 14, and 16.

As illustrated in FIG. 6, the screws are arranged in a vertical direction in the order of, from the top, the agitation screw 12, the supply screw 14, and the collection screw 16. A developing roller 18 is disposed at a height between the supply screw 14 and the collection screw 16 so that a part of the developing roller 18 is exposed from the developer container 10. Such a configuration downsizes the developing device 5C in a direction vertical to the axial direction. The developing roller 18 is disposed adjacent to the photoreceptor 4C of the image forming unit 3C so as to provide a toner to an electrostatic latent image formed on the photoreceptor 4C.

An incorporation part 11 and a control blade 13 are provided above the circumferential surface of the developing roller 18. The incorporation part 11 is configured to incorporate a developer supplied by the supply screw 14 onto the developing roller 18. The incorporation part 11 is disposed so that an end part 11a, which is an opposite end to the control blade 13, is provided on an upstream side from a point immediately above the developing roller 18 relative to the direction of rotation of the developing roller 18. The control blade 13 is configured to control the thickness of a developer layer formed on the developing roller 18. The control blade 13 is disposed on a downstream side from a point immediately above the developing roller 18 relative to the direction of rotation of the developing roller 18.

The above-described arrangement of the incorporation part 11 and the control blade 13 creates a space above the developing roller 18. Accordingly, the agitation screw 12 may have a larger diameter than conventional ones.

This means that the developing device 5C realizes increase in capacity without increasing the width in a direction vertical to the axial direction. The incorporation part 11 may be integrally provided with the developer container 10 as illustrated in FIG. 6, or alternatively, may be provided separate from the developer container 10.

An operation of the developing device 5C will be explained. The copier 1 controls the driving device such as a motor to rotate the screws 12, 14, and 16. The screws 12, 14, and 16 feed a developer within the developer container 10 by rotations. More particularly, developers which are fed to a left end by the agitation screw 12 fall onto the supply screw 14 and the collection screw 16. The developers are then fed to a right end by the supply screw 14 and the collection screw 16, and flow up onto the agitation screw 12. Accordingly, developers are circulated counterclockwise within the developer container 10.

The circulation feeds a part of developers from the supply screw 14 to the end part 11a of the incorporation part 11 and the incorporation part 11 incorporates the developers onto the developing roller 18. The end part 11a is disposed on an upstream side from a point immediately above the developing roller 18 relative to the direction of rotation of the developing roller 18, that is, adjacent to the supply roller 14. Even if developers are fed from the supply screw 14 with pressure variation, the incorporation part 11 relieves the pressure variation. Therefore, a constant amount of developers is stably fed to the developing roller 18. The developers on the developing roller 18 are controlled by the control blade 13 so as to form a thin layer thereof. At that time, the control blade 13 is supplied with a constant amount of developers and is received a constant pressure, and therefore the developers may not receive excessive pressures. A gap between the developing roller 18 and the control blade 13 is preferably from 0.1 to 0.5 mm so that an even and thin layer of developers is formed, resulting in high-density and even images. When the gap is too narrow, the resultant developer layer may be uneven and therefore the resultant image density may be low partially. When the gap is too wide, the resultant image density may be uneven. A thin layer of developers formed on the developing roller 18 supplies toners to an electrostatic latent image formed on the photoreceptor 4C to form a toner image. Residual developers remaining on the developing roller 18 are collected by the collection screw 16.

A description is now given of exemplary methods of mixing mother toner particles and external additives (hereinafter simply “additives”). In a case in which multiple additives each having different fluidities are mixed with mother toner particles or in which mother toner particles have high cohesive properties, two-step mixing methods are preferable. Specifically, an exemplary two-step mixing method includes the steps of mixing mother toner particles with a first additive which has the lowest fluidity giving ability in an amount of from 50 to 100% by weight based on the total weight of the additives (i. e., the first mixing step) using a mixer; and further mixing the rest of the first additive and other additives (i.e., the second mixing step), resulting in even mixing of the additives with the mother toner particles and proper fixation of the additives to the surfaces of the mother toner particles. In the first mixing step, torque is generated between the first additive and the mother toner particles, and therefore the first additive is pulverized into even particles.

Fluidity and chargeability of the resultant toner may vary depending on the amount of the first additive added in the first mixing step. Accordingly, the amount of the first additive added in the first mixing step may be changed as appropriate within a preferable range of from 50 to 100% by weight based on the total weight of the additives. When the amount is too small, the first additive may not be sufficiently pulverized into even particles in the first mixing step.

Since the first additive is evenly mixed with the mother toner particles in the first mixing step, the mother toner particles might have obtained improved fluidity in the first mixing step. Therefore, in the second mixing step, the rest of the first additive and other additives may be evenly fixed on the surfaces of the mother toner particles. Such additives properly fixed on the surfaces of the mother toner particles are unlikely to release therefrom for an extended period of time.

When a single additive is to be mixed with mother toner particles, an amount of from 30 to 50% by weight of the additive may be mixed using a mixer in the first mixing step and the rest of the additive may be mixed using a mixer in the second mixing step.

Specific examples of usable mixers include V-form mixers, locking mixers, Loedge Mixers, NAUTER MIXERS, HENSCHEL MIXERS and the like mixers. One preferred embodiment of the two-step mixing method includes mixing at a peripheral speed of from 3 to 10 m/s in the first mixing step and from 20 to 60 m/s in the second mixing step, both steps being performed using a mixer equipped with rotation blades. In this case, even pulverization in the first mixing step and fixation in the second mixing step are most effectively performed.

In the first mixing step, the peripheral speed is as low as possible so that large torque is generated. As the torque increases, pulverization of additives is performed more evenly. In addition, lower peripheral speeds do not apply stress to mother toner particles. Accordingly, the peripheral speed in the first mixing step is preferably from 3 to 10 m/s. When the peripheral speed is too small, mixing may be uneven. When the peripheral speed is too large, pulverization may be uneven.

The peripheral speed in the second mixing step is preferably from 20 to 60 m/s. As the peripheral speed increases, fixation of additives on mother toner particles is accelerated. However, when the peripheral speed is too large, for example when it exceeds 40 m/s, mother toner particles may be melted due to excessive application of stress. In a case in which the surfaces of mother toner particles are covered with additives in the first mixing step, adhesiveness between the mother toner particles is decreased and the surface roughness of the mother toner particles is increased. Therefore, the mother toner particles may not be melted and aggregated even when the peripheral speed exceeds 60 m/s. As a consequence, additives may be properly fixed on the mother toner particles.

Specific preferred examples of usable additives include, but are not limited to, hydrophobized silica, titanium oxide, aluminum oxide, and zirconium oxide. These materials can improve environmentally stable chargeability, cleanability, and/or transferability.

Next, hybrid resins for use in the present invention will be explained. A hybrid resin is a resin in which a condensation polymerization resin and an addition polymerization resin are chemically bound. Accordingly, hybrid resins are preferably prepared using monomers capable of reacting with monomers of both condensation and addition polymerizations resins. Specific examples of such monomers (hereinafter “ambireactive monomers”) include, but are not limited to, fumaric acid, acrylic acid, methacrylic acid, maleic acid, and dimethyl fumarate.

A suitable amount of the ambireactive monomers is from 1 to 25 parts by weight, preferably from 2 to 10 parts by weight, based on 100 parts by weight of raw materials of addition polymerization resins. When the amount is too small, colorant and charge controlling agents are dispersed insufficiently, resulting in deterioration of the resultant image quality. When the amount is too large, the resultant resin may gel.

Condensation polymerization and addition polymerization need not proceed and terminate simultaneously. These reactions may proceed independently at independent reacting temperatures and times.

The following is an exemplary method of preparing a hybrid resin. First, a reaction vessel is charged with monomers (hereinafter “condensation polymerization monomers”) of a condensation polymerization resin such as a polyester resin, other monomers (hereinafter “addition polymerization monomers”) of an addition polymerization resin such as a vinyl resin, and a polymerization initiator. The mixture is firstly subjected to a radical initiated polymerization so that the addition polymerization monomers are polymerized, and subsequently heated to be subjected to a condensation polymerization reaction so that the condensation polymerization monomers are polymerized.

Since the two independent reactions are sequentially performed in a single reaction vessel, two kinds of resins independently exist in the resultant resin.

Hybrid resins preferably have an acid value of from 15 to 70 mgKOH/g, more preferably from 20 to 50 mgKOH/g, and much more preferably from 20 to 30 mgKOH/g. In this case, release agents may be finely dispersed therein and low-temperature fixability and environmental stability are excellent. Higher acid values improve affinity of resins for paper, resulting in low-temperature fixing. When the acid value is too small, release agents may easily release from the hybrid resins. When the acid value is too large, the resultant toner may be affected by moisture in the air, resulting in poor charge stability.

Specific examples of suitable divalent acids for preparing polyester resins include, but are not limited to, aromatic dicarboxylic acids such as terephthalic acid, isophthalic acid, phthalic acid, diphenyl-p,p′-dicarboxylic acid, naphthalene-2,7-dicarboxylic acid, naphthalene-2,6-dicarboxylic acid, diphenylmethane-p,p′-dicarboxylic acid, benzophenone-4,4′-dicarboxylic acid, and 1,2-diphenoxyethane-p,p′-dicarboxylic acid; and other acids such as maleic acid, fumaric acid, glutaric acid, cyclohexane dicarboxylic acid, succinic acid, malonic acid, adipic acid, mesaconic acid, itaconic acid, citraconic acid, and sebacic acid; and anhydrides and lower alkyl esters of the above-described acids.

Specific examples of suitable divalent alcohols for preparing polyester resins include, but are not limited to, polyoxypropylene(2,2)-2,2-bis(4-hydroxyphenyl)propane, polyoxyethylene(2)-2,2-bis(4-hydroxyphenyl)propane, polyoxypropylene(6)-2,2-bis(4-hydroxyphenyl)propane, and polyoxypropylene(13)-2,2-bis(4-hydroxyohenyl)propane.

Specific examples of suitable divalent alcohols for preparing polyester resins further include, but are not limited to, diolssuchasethyleneglycol, diethyleneglycol, triethylene glycol, 1,2-propylene glycol, 1,3-propylene glycol, 1,4-butanediol, neopentyl glycol, and 1,4-butenediol, 1,4-bis(hydroxymethyl)cyclohexane, bisphenol A, and hydrogenated bisphenol A.

Specific examples of suitable acids for preparing polyester resins further include, but are not limited to, trimellitic acid, tri-n-ethyl 1,2,4-tricarboxylate, tri-n-butyl 1,2,4-tricarboxylate, tri-n-hexyl 1,2,4-tricarboxylate, tri-isobutyl 1,2,4-benzenetricarboxylate, tri-n-octyl 1,2,4-benzenetricarboxylate, and tri-2-ethylhexyl 1,2,4-benzenetricarboxylate.

Further, polyester resins may be prepared from acids having an alkyl or alkenyl substituent such as maleic acid, fumaric acid, glutaric acid, succinic acid, malonic acid, and adipic acid having n-dodecenyl group, isododecenyl group, n-dodecyl group, isododecyl group, or isooctyl group; and/or alcohols such as ethylene glycol, 1,3-propylenediol, tetramethylene glycol, 1,4-butylenediol, and 1,5-petyldiol.

Next, preferred embodiments of usable release agents will be described. Specific examples of suitable release agents include, but are not limited to, unesterified-fatty-acid-free carnauba waxes, montan waxes, and oxidized rice waxes. These waxes can be used alone or in combination. Preferably, carnauba waxes are in the form of microcrystal and have an acid value of 5 mgKOH/g or less. Carnauba waxes are preferably dispersed in binder resin with a particle diameter of 1 μm or less. Montan waxes may be prepared by purifying minerals. Preferably, montan waxes are in the form of microcrystal and have an acid value of from 5 to 14 mgKOH/g. Oxidized rice waxes may be prepared by air-oxidizing rice bran waxes and preferably have an acid value of from 10 to 30 mgKOH/g. Further, non-limited release agents such as solid silicone varnishes, higher fatty acid higher alcohol esters, montan ester waxes, and low-molecular-weight polypropylene waxes are used in combination. Usable waxes and release agents preferably have a volume average particle diameter of from 10 to 800 μm before being dispersed in binder resins.

Specific examples of usable colorants include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussianblue, Anthraquinone Blue, Fast Violet B, Methyl Violet Lake, cobalt violet, manganese violet, dioxaneviolet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These materials can be used alone or in combination. The toner preferably includes a colorant in an amount of from 0.1 to 50 parts by weight based on 100 parts by weight of binder resins.

Cyan toners preferably include cyan colorants generally used for offset printing so as to provide equivalent color quality. Specific examples of such cyan colorants include, but are not limited to, copper phthalocyanine pigments such as C. I. Pigment Blue 15, C. I. Pigment Blue 15-1, C. I. Pigment Blue 15-2, C. I. Pigment Blue 15-3, and C. I. Pigment Blue 15-4.

Magenta toners preferably include magenta colorants generally used for offset printing so as to provide equivalent color quality. Specific examples of such magenta colorants include, but are not limited to, pigments such as C. I. Pigment Red 57-1, C. I. Pigment Violet 19, C. I. Pigment Red 122, C. I. Pigment Red 146, C. I. Pigment Red 147, C. I. Pigment Red 176, C. I. Pigment Red 184, C. I. Pigment Red 185, and C. I. Pigment Red 269.

Yellow toners preferably include yellow colorants generally used for offset printing so as to provide equivalent color quality. Specific examples of such yellow colorants include, but are not limited to, pigments such as C. I. Pigment Yellow 14, C. I. Pigment Yellow 17, C. I. Pigment Yellow 74, C. I. Pigment Yellow 93, C. I. Pigment Yellow 151, C. I. Pigment Yellow 155, C. I. Pigment Yellow 154, C. I. Pigment Yellow 180, and C. I. Pigment Yellow 185.

When pigment particles aggregate in a toner or have a particle diameter of 200 nm or more, the toner may produce images with low transparency and low color saturation. When we recognize the color of an image formed with a toner or ink, light goes through a toner or ink layer and is reflected by paper, and eventually reaches our eyes. At the time light goes through the toner or ink layer, specific wavelengths of the light are absorbed and other specific wavelengths are not absorbed and go through the toner or ink layer. Accordingly, we recognize the colors of light which are not absorbed. In a case in which pigment particles have a large size or aggregate in a toner, the non-absorbed wavelengths may be absorbed or reflect diffusely, resulting in poor color saturation. In particular, toner layers are generally thicker than ink layers. Therefore, pigment particles are required to be more finely dispersed in a toner than in an ink so that a sufficient amount of light reaches the paper.

One possible method for preparing toners includes a method including a mixing process in which toner components including a binder resin, a colorant, and a release agent, and optionally a charge controlling agent, are mechanically mixed; a melt-kneading process in which the resultant mixture is melt-kneaded; a pulverization process in which the melt-kneaded mixture is pulverized into particles; and a classification process in which the pulverized particles are classified by size. Particles without a desired size (hereinafter “by-product particles”) produced in the pulverization and/or classification processes may be reused in the mixing and/or melt-kneading processes.

By-product particles include fine and coarse particles which do not have a desired size produced in the pulverization and/or classification processes. Such by-product particles are excluded from the final product. When the by-product particles are reused in the mixing and/or melt-kneading processes, it is preferable that from 1 to 50 parts by weight of by-product particles are mixed with from 50 to 99 parts by weight of raw materials.

The mixing process in which toner components including a binder resin, a colorant, and a release agent, and optionally a charge controlling agent and by-product particles, are mechanically mixed may be performed using a typical mixer equipped with rotatable blades under typical conditions.

The melt-kneading process may be performed using a single or double axis continuous kneader or a batch kneader such as a roll mill. The melt-kneading process is preferably performed under conditions such that molecular chains of binder resins are not cut. Specifically, the melt-kneading temperature is preferably set considering the softening point of binder resins. When the melt-kneading temperature is too much lower than the softening point, molecular chains are significantly cut. When the melt-kneading temperature is too much higher than the softening point, binder resins are not sufficiently mixed.

The pulverization process may include a coarse pulverization step and a subsequent fine pulverization step. The fine pulverization step may be performed using a countercurrent pulverizer. Specific examples of commercially available countercurrent pulverizers include, but are not limited to, PJM-I from Nippon Pneumatic Mfg. Co., Ltd.; MICRON JET MILL and COUNTER JET MILL from Hosokawa Micron Corporation; and CROSS JET MILL from Kurimoto, Ltd.

Countercurrent pulverizers are capable of increasing the circularities of resultant toner particles and smoothing the surfaces thereof. Such toner particles may be well packed on an isolated dot when developing a latent image. Accordingly, isolated dots are faithfully reproduced on a photoreceptor and therefore high-grade images with high granularity and gradation may be produced.

In order to improve classification efficiency, a melt-kneaded mixture may be preliminarily pulverized into particles having weight average and/or mode particle diameters of from 5 to 15 μm using a mechanical pulverizer before being pulverized using a countercurrent pulverizer (i.e., the coarse pulverization step). This is because, without such a preliminary pulverization, there is a possibility that countercurrent pulverizers may chip charging sites away from the surfaces of particles and produce highly-charged ultrafine particles with a particle diameter of 2 μm or less. It is too difficult to remove such highly-charged ultrafine particles with a particle diameter of 2 μm or less in succeeding processes. When a melt-kneaded mixture is preliminarily pulverized into particles having weight average and/or mode particle diameters of from 5 to 15 μm using a mechanical pulverizer, a countercurrent pulverizer does not excessively increase the circularities of resultant toner particles and does not produce a large number of ultrafine particles.

In a case in which a melt-kneaded mixture is not subjected to a preliminary pulverization using a mechanical pulverizer, a countercurrent pulverizer may waste energy and excessively increase the circularities of resultant toner particles in the process of pulverizing the melt-kneaded mixture into particles having a particle diameter of from 4 to 7 μm. An increase of the circularity causes insufficient cleaning of photoreceptors. In other words, such particles with a large circularity are difficult to be removed from the surfaces of photoreceptors. Moreover, in the above case, a countercurrent pulverizer may produce a large amount of ultrafine particles. When the pulverized particles include 30% by number or more of ultrafine particles having a particle diameter of 2 μm or less, it is very difficult to remove them by a dry classification method. For example, it is difficult to remove ultrafine particles in one cycle such that the resultant particles include particles having a particle diameter of from 0.6 to 2.0 μm in an amount of 10% by number or less.

Wet classification methods such as a method using a decanter centrifugal separat or are capable of removing ultrafine particles having a particle diameter of from 0.6 to 2.0 μm. However, wet classification methods are not preferable in terms of productivity. Since wet classification methods use surfactants for the purpose of dispersing toner particles in water, chargeability of the toner particles may be adversely affected unless the surfactants are washed away completely. Accordingly, dry classification methods are more preferable.

As described above, in a case in which a melt-kneaded mixture is preliminarily pulverized into particles having weight average and/or mode particle diameters of from 5 to 15 μm, preferably from 5 to 10 μm, using a mechanical pulverizer, a countercurrent pulverizer may reform the surfaces of resultant tonerparticles without increasing the circularities of the toner particles and producing ultrafine particles.

Specific examples of commercially available mechanical pulverizers include, but are not limited to, KRYPTRON from Kawasaki Heavy Industries, Ltd., TURBO MILL from Turbo Kogyo Co., Ltd., and ACM PULVERIZER and INOMIZER from Hosokawa Micron Corporation. The resultant particle diameter can be varied by controlling the rotation number of rotors.

The classification process may be performed using a swirling airflow classifier which may have the following configuration. A classification cover and a classification plate are provided above and below. The under surface of the classification cover and the upper surface of the classification plate are formed into a circular cone in which the apex is upward. A classification chamber is formed between the under and upper surfaces of the circular cone. Multiple louvers are circularly disposed on an outer surface of the classification chamber and multiple inflow paths for secondary air are disposed between the adjacent louvers. Such a configuration swirls particles in the classification chamber at a high speed so that fine particles and coarse particles are centrifugally separated. The fine particles are discharged from a discharge pipe connected to a center part of the classification plate and the coarse particles are discharged from another discharge opening formed on an outer circumference of the classification plate. Swirling airflow classifiers with the above-described configuration may efficiently remove ultrafine particles having a particle diameter of 2 μm or less. Specific examples of commercially available swirling airflow classifiers include, but are not limited to, MICRO SPIN from Nippon Pneumatic Mfg. Co., Ltd.

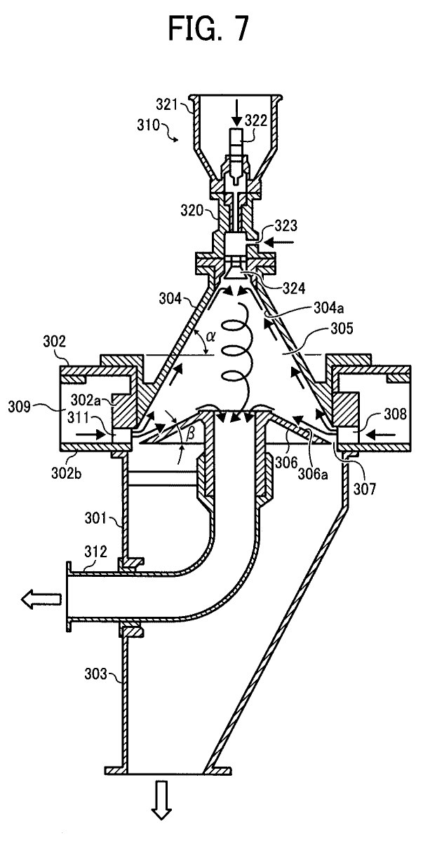

FIG. 7 is a schematic view illustrating an embodiment of a swirling airflow classifier. A casing 301 includes a cylindrical upper casing 302 and a conical lower casing 303 in which the diameter is decreasing downward. A supply device 310 is disposed above a cover 304. The supply device 310 includes a powder supply cylinder 320 connected to a center part of the cover 304, a hopper 321 connected to an upper part of the powder supply cylinder 320, and an air injection nozzle 322 provided inside the hopper 321. The air injection nozzle 322 injects compressed air into the powder supply cylinder 320 so that powders in the hopper 321 are sucked into the power supply cylinder 320.

The cover 304 is detachably attached to the upper casing 302 by bolting, etc. A classification plate 306 is disposed below the cover 304 so that a classification chamber 305 is provided therebetween. A discharge opening 307 configured to discharge coarse particles is circularly provided between an outer circumference of the classification plate 306 and an inner circumference of the upper casing 302.

An under surface 304a of the cover 304 and an upper surface 306a of the classification plate 306 are formed into a circular cone in which the apex is upward. An inclination α of the under surface 304a of the cover 304 relative to the horizontal surface is greater than an inclination β 0 of the upper surface 306a of the classification plate 306 relative to the horizontal surface.

The upper casing 302 includes an upper ring 302a and a lower ring 302b. Multiple louvers 308 are provided between the upper and lower rings 302a and 302b at predetermined intervals in a circumferential direction of the classification chamber 305.

The angle of each of the louvers 308 is controllable relative to the center of a vertical axis. Flow paths are provided between adjacent louvers 308. The flow paths are configured to inflow a secondary air from outside toward a swirling direction of powders in the classification chamber 305.

The outer diameter of the outer circumferential edge of the under surface 304a of the cover 304 and the inner diameter of the upper casing 302 are the same. The outer circumferential edge of the under surface 304a is roughly equal to the upper edge of the louvers 308.

An air injection aperture 323 is provided on the powder supply cylinder 320. A compressed air is injected toward an outer circumference of the powder supply cylinder 20 through the air injection aperture 323 so that the compressed air swirls a solid-gas mixture fluid which is flowing downward in the powder supply chamber 20. The swirling solid-gas mixture fluid is then supplied to the classification chamber 305 along an outer circumference of a cone 324 provided on a lower end opening of the powder supply cylinder 320. A discharge cylinder 312 configured to discharge fine particles is connected to a center part of the classification plate 306. The discharge cylinder 312 penetrates the lower casing 303.

A compressed air supply device 309 configured to inject a compressed air from between adjacent louvers 308 into the classification chamber 305 is provided on outer circumferences of the louvers 308. The compressed air supply device 309 includes injection nozzles 311 provided between adjacent louvers 308. The injection nozzles 311 inject a compressed air toward an outer circumference of the classification chamber 305.

When a toner is subjected to classification using the above-described classifier, a solid-gas mixture fluid of a compressed air is injected from the cone 324 provided on the lower end opening of the powder supply cylinder 320 toward an outer circumference of the classification chamber 305, while a suction force is applied in the discharge cylinder 312. The above-described classifier may be suitable for smooth and even feeding of coarsely pulverized particles having weight average and/or mode particle diameters of from 5 to 15 μm, that is, a preferred embodiment of preparing the toner of the present invention. Optionally, a spiral guide wall may be formed on an inner wall of the cone 324.

The solid-gas mixture fluid injected into the classification chamber 305 swirls therein. Simultaneously, a secondary air flows into the classification chamber 305 through the flow paths in the louvers 308. The secondary air accelerates swirling of powders in the classification chamber 305 so that fine particles and coarse particles are centrifugally separated.

The fine particles migrate to a center of the classification chamber 305 to be discharged from the discharge cylinder 312 by suction. The coarse particles migrate to an outer circumference of the classification chamber 305 to be discharged to the lower casing 303.

A supply device configured to supply a solid-gas mixture fluid to the classification chamber 305 may be provided above the cover 304.

The toner of the present invention may be mixed with a carrier to be used as a two-component developer. Specific examples of suitable carriers include, but are not limited to, fine particles of materials such as glass, iron, ferrites, nickel, zircon, and silica with a particle diameter of from 30 to 1,000 μm; and these fine particles covered with resins such as styrene-acrylic resins, silicone resins, polyamide resins, and polyvinylidene fluoride. Preferably, carriers have a particle diameter of from 20 to 40 μm from the viewpoint of charging ability.

Next, measurement methods of various toner properties will be explained in detail.

### (Molecular Weight Distribution)

Molecular weight distributions of THF(tetrahydrofuran)-soluble components of toners and binder resins may be measured by GPC (gel permeation chromatography) using THF as a solvent. For example, a high-performance liquid chromatograph 150C from Waters may be used as a suitable GPC instrument.

A measurement specimen may be prepared as follows. First, a sample and THF are mixed so that the sample concentration becomes about 5 mg/ml. After being left at rest for 5 to 6 hours at room temperature, the mixture is sufficiently shaken so that THF and the sample are well mixed, and further left at rest for 2 hours at room temperature. The total time from starting mixing to finishing leaving will be 24 hours or more. The mixture is then filtered with a sample disposal filter having a pore size of 0.45 μm such as MAISHORI DISK H-25-2 from Tosoh Corporation and EKIKURO DISK 25CR from German Science Japan. Thus, a measurement specimen, which is a THF solution of the sample, is prepared.

In a GPC instrument, columns are stabilized in a heat chamber at 40° C. THF serving as a solvent is flown therein at a flow speed of 1 ml/min and the measurement specimen prepared above in an amount of about 10 μl is injected therein. A molecular weight distribution of the sample is determined from a calibration curve created from a couple of monodisperse polystyrene standard samples. Preferably, 10 polystyrene standard samples having a molecular weight of from 10² to 10⁷ from Tosoh Corporation may be preferably used for creating a calibration curve. As a detector, RI (refractive index) detectors are preferable. As columns, commercially available polystyrenegel columns such as TSKgel G1000H (HXL), G2000H (HXL), G3000H (HXL) , G4000H (HXL) , G5000H (HXL) , G6000H (HXL) , G7000H (HXL), and TSKguardcolum all from Tosoh Corporation are preferably used in combination.

A measurement is performed from a point in which a chromatograph rises up from a baseline (a high-molecular-weight side) to a point in which a molecular weight is about 400 (a low-molecular-weight side).

For example, the number average molecular weight (Mn), weight average molecular weight (Mw), peak molecular weight (Mp) at which the chromatogram has a maximum height, and ratio of components having a molecular weight of 1,500 or less may be determined from a chromatogram obtained under the following conditions.

GPC instrument: HCL-8120 from Tosoh Corporation Column: TSKgelIGMHXL×2, TSKgelmultiporeHXL-M×1

Measurement temperature: 40° C.

Sample solution: 0.25% THF solution

Injection volume: 100 μl

Detector: Refractive index detector

Standard substance: Polystyrene

### (Particle Diameter Distribution)

Particle diameter distributions of toners may be measured by a Coulter method which uses an instrument such as COULTER MULTISIZER II or III (from Beckman Coulter K. K.), for example. A typical measuring method is as follows:
(1) 0.1 to 5 ml of a surfactant (preferably an alkylbenzene sulfonate) is included as a dispersant in 100 to 150 ml of an electrolyte (i.e., about 1% NaCl aqueous solution of a first grade sodium chloride such as ISOTON-II from Coulter Electrons Inc.);
(2) 2 to 20 mg of a toner is added to the electrolyte and dispersed using an ultrasonic dispersing machine for about 1 to 3 minutes to prepare a toner suspension liquid;
(3) the weight and number of toner particles in the toner suspension liquid are measured by the above instrument using an aperture of 100 μm to determine the weight and number distribution thereof; and
(4) the weight average particle diameter (D4) and the number average particle diameter (D1) are determined from the weight and number distributions, respectively.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.

### (Color Reproducibility)

To evaluate color reproducibility, yellow, magenta, cyan, red, blue, and green images each having an image density of from 1.70 to 1.80 are produced on a fixing paper TYPE 70W from Ricoh Co., Ltd. using a color copier IMAGIO NEO C285 from Ricoh Co., Ltd.

The produced images are subjected to a measurement of L* (brightness), a* (red-green scale), and b* (yellow-blue scale) of the L*a*b* color system using SPECTROPHOTOMETER SP 68 from X-Rite, and the volume of a three-dimensional color space formed with the measured L*, a*, and b* values are calculated. The ratio of the above-calculated volume of the L*a*b* color space to the volume of the standard color space Japan Color 2007 established by ISO/TC Domestic Committee of Japan Printing Machinery Association is measured. As the ratio approaches 1.0, the image has better color reproducibility.

### (Gloss)

A toner image having a deposition amount of 1.0+0.1 mg/cm² is developed using a color copier IMAGIO NEO C285 from Ricoh Co., Ltd. The developed image is then fixed on a fixing paper TYPE 70W from Ricoh Co., Ltd. when the surface temperature of the fixing belt is 170° C. The fixed image is subjected to a measurement of gloss using a gloss meter from Nippon Denshoku industries Co., Ltd. at an incident angle of 60°.

### (Fogging)

A developer is set in a color copier IMAGIO NEO C285 from Ricoh Co., Ltd. First, 20 sheets of an image chart in which 12% of the area is occupied by images are produced, followed by a pause for 10 seconds. This operation is repeated so that 10,000 sheets of the image chart are produced in total. After the 10,000^{th} sheet is produced, the image is observed to determine whether or not fogging is occurring or not, and results are graded as follows.

A: No fogging is occurring.

B: Fogging is occurring slightly, but not problem in practical use.

C: Fogging is significantly occurring.

### (Sharpness)

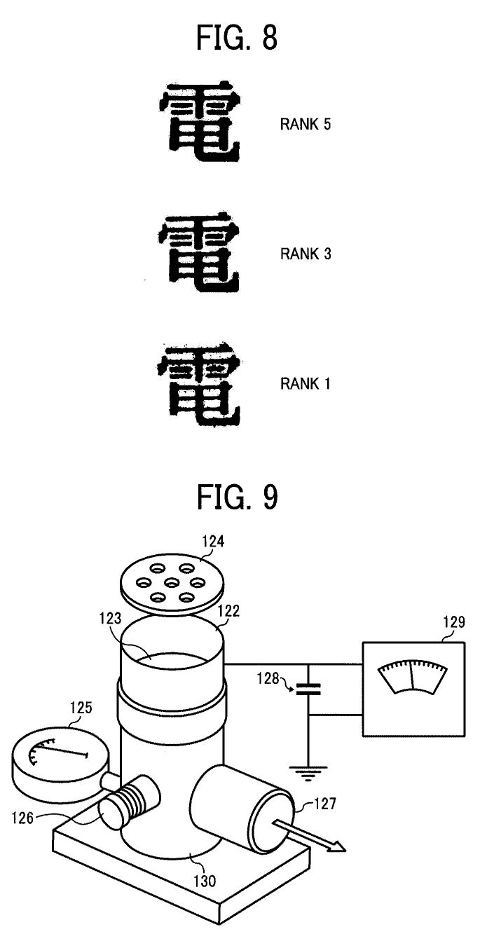

Sharpness is evaluated by observing the images produced in the above evaluation of fogging. Evaluation results are graded into 5 ranks. The greater the rank, the better the sharpness. Example images with ranks 1, 3, and 5 are shown in FIG. 8.

### (Storage Stability)

Storage stability may be measured by a penetration test based on JIS K2235-1991. First, atoner is contained in a 50-ml glass container and set in a constant-temperature chamber at 50° C. for 20 hours. After being cooled to room temperature, the toner is subjected to the penetration test. The larger the penetration, the better the storage stability.

The penetration is preferably 15 mm or more, and more preferably from 20 to 30 mm. When the penetration is too small, storage stability may deteriorate. Evaluation results are graded as follows.

A: The penetration is from 20 to 30 mm.

B: The penetration is from 15 to 20 mm.

C: The penetration is less than 15 mm.

### (Hot Offset Temperature)

A color copier IMAGIO NEO C285 from Ricoh Co., Ltd. is modified so as to contain a fixing belt having a diameter of φ60 which includes a nickel substrate having a thickness of about 40 μm and a release layer including asilicone rubber having a thickness of about 150 μm covered with a PFA layer having a thickness of 20 μm. Further, the belt tension is set to 1.5 kg per one side, the belt speed is set to 180 mm/sec, the fixing nip width is set to 10 mm, the heater outputs for heating and pressing are set to 650 W and 400 W, respectively, and the fixing pressure is set to 40 kg.

Images are fixed on a paper TYPE 70W from Ricoh Co., Ltd. while changing the temperature of the fixing belt at an increment of 5° C. to determine the temperature at and above which hot offset occurs (hereinafter “hot offset temperature”).

### (Minimum Fixable Temperature)

Images are fixed on a paper TYPE 70W from Ricoh Co., Ltd. while changing the temperature of the fixing belt at a decrement of 5° C. using the modified color copier IMAGIO NEO C285used above.

The fixed images are subjected to a measurement of image density using a Macbeth densitometer. Thereafter, a mending tape (from 3M) is adhered onto the fixed images and a specific amount of pressure is applied thereon. After peeling off the mending tape, the mending tape is subjected to a measurement of image density using a Macbeth densitometer. The fixing ratio is calculated from the following equation:

Fixing Ratio (%)=ID(tape)/ID(paper)

Wherein ID (paper) represents an image density of a fixed image on paper and ID (tape) represents an image density of a mending tape which has been adhered onto the fixed image with a specific pressure.

The minimum fixable temperature is a temperature at and below which the fixing ratio is 80% or less.

### (Contamination of Fixing Belt)

After the 10,000^{th} sheet is produced in the above-described evaluation for fogging, the fixing belt is visually observed. Results are graded as follows.

A: No contamination is observed.

B: The fixing belt is slightly contaminated but the resultant image is not contaminated. No problem in practical use.

C: Both the fixing belt and resultant image are contaminated.

### (Charge Quantity)

To measure charge quantity of a toner, first, 3.5 g of a toner and 46.5 g of a carrier such as EFV-200/300 from Powdertech Co., Ltd. are contained in a polyethylene container and left at rest for2 days at temperatures of from 21 to 25° C. and humidities of from 55 to 63%. The container with a lid is shaken for 240 seconds using a TURBULA MIXER, and thereafter about 0.5 mg of the toner is weighed to be subjected to a measurement of triboelectrically-charged quantity by a suction method.

FIG. 9 is a schematic view illustrating an embodiment of a charge quantity measuring instrument. A toner is contained in a metallic container 122, the bottom of which is equipped with a conductive screen 123 which is a 635 mesh that does not pass carrier particles. After putting a metallic lid on the metallic container 122, a suction device 130 sucks from a suction opening 127 while controlling an air volume control valve 126 so that a vacuum gauge 25 indicates 250 mmH₂O. The suction is continued for 1 minute. Total charge quantity may be determined from a voltage V (V) indicated by an electrometer 129 and a capacity C (μF) indicated by a condenser 128. By dividing the total charge quantity by the amount (g) of toner particles sucked, triboelectrically-charged quantity (μC/g) is calculated.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Polyester Resins 1 to 3

A reaction vessel equipped with a condenser, a stirrer, and a nitrogen inlet pipe is charged with materials described in Table 1-1. The reaction vessel is set in a mantle heater and the mixture is agitated at 30° C. under nitrogen airflow. Subsequently, the mixture is heated from 30 to 200° C. at a heating rate of 10° C./min. The mixture is subjected to a reaction at 200° C. until the product has a desired 1/2 flow starting temperature. After terminating the reaction, the mixture is cooled to 30° C. at a cooling rate of 10° C./min. Thus, polyester resins 1 to 3 are prepared. The 1/2 flow starting temperature (T_{1/2}), peak top molecular weight (Mp), and weight average molecular weight (Mw) are shown in Table 1-2.

TABLE 1-1

| | Polyester Resin No. | | |
|---|---|---|---|
| | 1 | 2 | 3 |
| BPA-PO* | 780 (1.5) | 1248 (2.4) | — |
| BPA-EO** | 525 (1.5) | 210 (0.6) | — |
| Ethylene Glycol | — | — | 124 (2.0) |
| 1,4-Butanediol | — | — | 90.1 (1.0) |
| Terephthalic Acid | 193 (1.0) | — | — |
| Maleic Acid | — | 116 (1.0) | 23 (0.2) |
| Dodecenyl | — | 400.5 (1.5) | — |
| Succinic | | | |
| Anhydride | | | |
| Fumaric Acid | 222.3 (1.9) | — | 257.4 (2.2) |
| Trimellitic | 19.2 (0.1) | 96 (0.5) | 115.2 (0.6) |
| Anhydride | | | |
| Catalyst*** | 0.6% by | 0.8% by | 0.2% by |
| | weight of | weight of Tin(II) | weight of Tin (II) |
| | Tin(II) Octylate | Dioctanoate | Distearate |

Values are in parts, and values in brackets refer to molar ratios.
*Propylene oxide 2.2 mol adduct of bisphenol A
**Ethylene oxide 2.2 mol adduct of bisphenol A
***Based on 100 parts of binder resins

TABLE 1-2

| | Polyester Resin No. | | |
|---|---|---|---|
| | 1 | 2 | 3 |
| T½ (° C.) | 98 | 122 | 115 |
| Mp | 2,300 | 8,200 | 7,000 |
| Mw | 5,200 | 56,000 | 35,000 |

### Synthesis of Hybrid Resins 4 to 6

Addition polymerization monomers described in Table 2-1 and t-butyl hydroperoxide serving as a polymerization initiator are contained in a dropping funnel. Condensation polymerization monomers described in Table 2-1 are contained in a flask equipped with a stainless stirrer, a flow-down condenser, a nitrogen inlet pipe, and a thermometer and agitated at 135° C. under nitrogen atmosphere. The mixture of the addition polymerization monomers in the dropping funnel is added to the flask over a period of 5 hours. The mixture is further aged for 6 hours at 130° C., and subsequently heated to 220° C. Thus, hybrid resins 4,5,and 6 are prepared. The 1/2 flow starting temperature (T_{1/2}), peak top molecular weight (Mp), and weight average molecular weight (Mw) are shown in Table 2-2.

TABLE 2-1

| | | Hybrid Resin No. | | |
|---|---|---|---|---|
| | | 4 | 5 | 6 |
| Condensation | BPA-PO* | 1040 (0.2) | 260 (0.5) | 260 (0.5) |
| Polymerization | BPA-EO** | 350 (1.0) | 875 (2.5) | 875 (2.5) |
| Monomers and | Terephthalic | 337.4 (1.8) | 93.6 (0.8) | 93.6 (0.8) |
| Catalyst | Acid | | | |
| | Maleic Acid | — | 116 (1.0) | 116 (1.0) |
| | Dodecenyl | 53.4 (0.2) | — | — |
| | Succinic | | | |
| | Anhydride | | | |
| | Fumaric Acid | 58.5 (0.5) | — | — |
| | Trimellitic | 96 (0.5) | — | — |
| | Anhydride | | | |
| | Catalyst*** | 1.2% by | 0.1% by | 0.3% by |
| | | weight of | weight of | weight of |
| | | Tin(II) | Tin(II) | Dibutyltin |
| | | Oxide | Octylate | Oxide |
| Addition | Styrene | 120 | 118 | 118 |
| Polymerization | Butyl Acrylate | 21 | — | — |
| Monomers | Methyl | — | 32 | 32 |
| | Methacrylate | | | |
| | Benzoyl | 5.5 | 5 | 5 |
| | Peroxide (BPO) | | | |

Values are in parts, and values in brackets refer to molar ratios.
*Propylene oxide 2.2 mol adduct of bisphenol A
**Ethylene oxide 2.2 mol adduct of bisphenol A
***Based on 100 parts of binder resins

TABLE 2-2

| | Hybrid Resin No. | | |
|---|---|---|---|
| | 4 | 5 | 6 |
| T½ (° C.) | 110 | 105 | 102 |
| Mp | 4,000 | 3,000 | 2,600 |
| Mw | 28,000 | 15,000 | 13,800 |

### Synthesis of Styrene-Acrylic Resin 7

A flask is charged with 140 parts of ion-exchange water, 1.5 parts of a nonionic surfactant (NONIPOL 400 from Sanyo Chemical Industries, Ltd.), and4 parts of an anionic surfactant (NEOGEN SC from Dai-ichi Kogyo Seiyaku Co., Ltd.), and is subjected to nitrogen substitution. The mixture is added to a mixture of 70 parts of styrene and 30 parts of butyl acrylate using a funnel while being subjected to nitrogen substitution. The mixture is heated to 90° C. for 5 hours in an oil bath so that a suspension polymerization is performed. After the termination of the polymerization, the mixture is cooled, repeatedly filtered and washed for 5 times, and dried using an evaporator. Thus, a styrene-acrylic resin having a peak molecular weight (Mp) of 3,000, a 1/2 flow starting temperature of 90° C., and a weight average molecular weight (Mw) of 3,000 is prepared.

### Preparation of Charge Controlling Agent (CCA) 1

First, 20 g of 3,5-di-tertiary-butyl salicylic acid and 30 parts of a 25% aqueous solution of sodium hydroxide are dissolved in 300 to 400 parts of water. The mixture is heated to 50° C. at a heating rate of 5° C./min while being agitated. A solution in which 120 parts of zirconium oxychloride is dissolved in 80 parts of water is further added to thereto. After agitating for 1 hour at the same temperature, the mixture is cooled at a cooling rate of 5° C./min, and 8 parts of the 25% aqueous solution of sodium hydroxide are added thereto so that the pH becomes from 7.5 to 8.0. The deposited crystals are filtered, washed with water, and dried. Thus, 30 parts of white crystals of a charge controlling agent 1 are prepared.

### Preparation of Charge Controlling Agent (CCA) 2

The procedure for preparation of the charge controlling agent 1 is repeated except that 120 parts of zirconium oxychloride are replaced with 220 parts of aluminum oxychloride. Thus, a charge controlling agent 2 is prepared.

### Preparation of Charge Controlling Agent (CCA) 3

The procedure for preparation of the charge controlling agent 1 is repeated except that 3,5-di-tertiary-butyl salicylic acid is replaced with 3,5-dichlorosalicylic acid. Thus, a charge controlling agent 3 is prepared.

### Toner Examples 1 to 9

Raw materials described in Table 3-1 are preliminarily mixed using HENSCHEL MIXER FM10B from Mitsui Mining Co., Ltd. and the mixture is then kneaded using a TWIN SCREW EXTRUDER PCM from Ikegai Co., Ltd. The mixture is pulverized into fine particles using an ultrasonic jet pulverizer LABOJET from Nippon Pneumatic Mfg. Co., Ltd., and the fine particles are classified by size using an airflow classifier MDS-I from Nippon Pneumatic Mfg. Co., Ltd. so as to have a weight average particle diameter described in Table 3-2. Thus, each of the mother toners is prepared.

Next, 100 parts of each of the mother toners is mixed with 3.0 parts of a colloidal silica H-3004 from Wacker Chemie AG. Thus, toners 1 to 9 are prepared. Properties of the toners 1 to 9 are shown in Table 3-2.

Further, each of the toners 1 to 9 is mixed with a silicone-coated carrier having an average particle diameter of 30 μm so that the resultant developer has a toner concentration of 7% by weight. Thus, developers 1 to 9 are prepared.

TABLE 3-1

| | Example No. | | | | | | | | |
|---|---|---|---|---|---|---|---|---|---|
| | 1 | 2 | 3 | 4 | 5 | 6 | 7 | 8 | 9 |
| Polyester Resin 1 | 70 | 70 | 70 | — | — | — | 50 | — | — |
| Polyester Resin 2 | — | — | — | — | — | — | 50 | — | — |
| Polyester Resin 3 | 30 | 30 | 30 | — | 100 | 20 | — | 40 | — |
| Hybrid Resin 4 | — | — | — | 100 | — | 80 | — | — | — |
| Hybrid Resin 5 | — | — | — | — | — | — | — | 60 | — |
| Hybrid Resin 6 | — | — | — | — | — | — | — | — | 100 |
| Paraffin Wax* | 5 | 5 | 5 | — | — | — | 5 | 5 | — |
| Carnauba Wax** | — | — | — | 8 | 8 | 8 | — | — | 8 |
| CCA 1 | 2.5 | 2.5 | 2.5 | — | — | — | 1.4 | — | — |
| CCA 2 | — | — | — | 2.5 | 0.6 | — | — | 1.2 | 2.5 |
| CCA 3 | — | — | — | — | — | 4 | — | — | — |
| Pigments | | | | | | | | | |
| Pigment Yellow 74 | 8 | 8 | 8 | 8 | 8 | 8 | 8 | 8 | 8 |
| Pigment Red 122 | 6 | 6 | 6 | 6 | 6 | 6 | 6 | 6 | 6 |
| Pigment Blue 15-3 | 6 | 6 | 6 | 6 | 6 | 6 | 6 | 6 | 6 |
| REGAL 400R*** | 6 | 6 | 6 | 6 | 6 | 6 | 6 | 6 | 6 |

Values are in parts.
*Paraffin wax having a melting point of 75° C.
**Carnauba wax having a meting point of 83° C. from Toakasei Co., Ltd.
***REGAL 400R from Cabot

TABLE 3-2

| | | Example No. | | | | | | | | |
|---|---|---|---|---|---|---|---|---|---|---|
| | | 1 | 2 | 3 | 4 | 5 | 6 | 7 | 8 | 9 |
| Toner | T½ (° C.) | 120 | 120 | 120 | 130 | 121 | 128 | 122 | 125 | 129 |
| Properties | G′ (×10⁴ pa) | 5 | 5 | 5 | 12 | 16 | 10 | 20 | 8 | 11 |
| | Tan δ | 3.0 | 3.0 | 3.0 | 2.2 | 1.5 | 1.2 | 1.0 | 2.8 | 1.6 |
| | D4 (μm) | 3.0 | 2.5 | 5.5 | 5.0 | 4.5 | 4.2 | 3.5 | 4.2 | 3.2 |
| | Mp | 2400 | 2400 | 2400 | 4000 | 6800 | 5000 | 6000 | 3200 | 2600 |
| Toner | Color | 0.95 | 0.95 | 0.95 | 0.96 | 0.93 | 0.91 | 0.94 | 0.89 | 0.87 |
| Evaluation | Reproducibility | | | | | | | | | |
| Results | Gloss | 30 | 30 | 30 | 28 | 25 | 23 | 25 | 29 | 20 |
| | Sharpness | 5 | 5 | 4 | 5 | 5 | 5 | 5 | 5 | 5 |
| | Hot Offset | 180 | 180 | 180 | 180 | 180 | 180 | 180 | 180 | 180 |
| | Temperature | | | | | | | | | |
| | (° C.) | | | | | | | | | |
| | Minimum | 120 | 125 | 120 | 120 | 125 | 120 | 120 | 120 | 120 |
| | Fixable | | | | | | | | | |
| | Temperature | | | | | | | | | |
| | (° C.) | | | | | | | | | |
| | Contamination | B | B | B | A | A | A | A | A | A |
| | of Fixing Belt | | | | | | | | | |
| | Charge | 45 | 48 | 41 | 43 | 38 | 37 | 45 | 46 | 49 |
| | Quantity | | | | | | | | | |
| | (−μC/g) | | | | | | | | | |
| | Fogging | A | A | A | A | A | A | A | A | A |
| | Storage | A | A | A | B | A | A | A | A | A |
| | Stability | | | | | | | | | |

### Comparative Toner Examples 1 to 5

Raw materials described in Table 4-1 are preliminarily mixed using HENSCHEL MIXER FM10B from Mitsui Mining Co., Ltd. and the mixture is then kneaded using a TWIN SCREW EXTRUDER PCM from Ikegai Co., Ltd. The mixture is pulverized into fine particles using an ultrasonic jet pulverizer LABOJET from Nippon Pneumatic Mfg. Co., Ltd., and the fine particles are classified by size using an airflow classifier MDS-I from Nippon Pneumatic Mfg. Co., Ltd. so as to have a weight average particle diameter described in Table 4-2. Thus, each of the mother toners is prepared.

Next, 100 parts of each of the mother toners is mixed with 3.0 parts of a colloidal silica H-3004 from Wacker Chemie AG. Thus, comparative toners 1 to 5 are prepared. Properties of the comparative toners 1 to 5 are shown in Table 4-2.

Further, each of the comparative toners 1 to 5 is mixed with a silicone-coated carrier having an average particle diameter of 30 μm so that the resultant developer has a toner concentration of 7% by weight. Thus, comparative developers 1 to 5 are prepared.

TABLE 4-1

| | Comparative Example No. | | | | |
|---|---|---|---|---|---|
| | 1 | 2 | 3 | 4 | 5 |
| Polyester Resin 1 | — | — | 50 | 100 | — |
| Polyester Resin 2 | 100 | — | — | — | — |
| Polyester Resin 3 | — | — | 45 | — | — |
| Hybrid Resin 4 | — | — | — | — | 100 |
| Hybrid Resin 5 | — | 100 | — | — | — |
| Hybrid Resin 6 | — | — | 5 | — | — |
| Paraffin Wax* | 5 | 5 | 5 | 5 | 5 |
| Carnauba Wax** | — | — | — | — | — |
| CCA 1 | — | 4.0 | 2.0 | — | 0.2 |
| CCA 2 | — | — | — | 3.0 | — |
| CCA 3 | — | — | — | — | — |
| E-304**** | 2.5 | — | — | — | — |
| (Zinc Salicylate) | | | | | |
| Pigments | | | | | |
| Pigment Yellow 74 | 8 | 8 | 8 | 8 | 8 |
| Pigment Red 122 | 6 | 6 | 6 | 6 | 6 |
| Pigment Blue 15-3 | 6 | 6 | 6 | 6 | 6 |
| REGAL 400R*** | 6 | 6 | 6 | 6 | 6 |

Values are in parts.
*Paraffin wax having a melting point of 75° C.
**Carnauba wax having a meting point of 83° C. from Toakasei Co., Ltd.
***REGAL 400R from Cabot
****E-304 from Orient Chemical Industries, Ltd.

TABLE 4-2

| | | Comparative Example No. | | | | |
|---|---|---|---|---|---|---|
| | | 1 | 2 | 3 | 4 | 5 |
| Toner Properties | T½ (° C.) | 120 | 135 | 125 | 128 | 113 |
| | G′ (×10⁴ pa) | 250 | 8 | 6 | 4.1 | 8 |
| | Tan δ | 0.9 | 1.6 | 2.1 | 3.5 | 3.2 |
| | D4 (μm) | 4.5 | 3.5 | 4.2 | 5.1 | 4.8 |
| | Mp | 8000 | 3000 | 4200 | 2300 | 4000 |
| Toner Evaluation | Color Reproducibility | 0.75 | 0.71 | 0.74 | 0.91 | 0.82 |
| Results | Gloss | 7 | 8 | 12 | 29 | 10 |
| | Sharpness | 5 | 5 | 5 | 5 | 5 |
| | Hot Offset Temperature (° C.) | 180 | 180 | 180 | 160 | 150 |
| | Minimum Fixable | 130 | 135 | 130 | 120 | 120 |
| | Temperature (° C.) | | | | | |
| | Contamination of Fixing Belt | A | A | A | C | C |
| | Charge Quantity (−μC/g) | 48 | 54 | 43 | 45 | 40 |
| | Fogging | A | A | A | C | A |
| | Storage Stability | A | A | A | A | A |

This document claims priority and contains subject matter related to Japanese Patent Application No. 2008-067396, filed on Mar. 17, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by letters patent of the United States is:

1. A toner, comprising:
a binder resin selected from the group consisting of (a) a polyester resin, (b) a hybrid resin comprising a polyester unit and a vinyl copolymer unit, and (c) a mixture of a polyester resin and a hybrid resin;
a colorant;
a release agent; and
at least one of an aluminum compound and a zirconium compound of an aromatic oxycarboxylic acid;
wherein the toner has a 1/2 flow starting temperature of from 120 to 130° C. measured by a flow tester, and
wherein the toner has a storage elastic modulus (G′) of from 50,000 to 200,000 Pa and a tan δ(G″/G′) that is a ratio of a loss elastic modulus (G″) to a storage elastic modulus (G′) of from 1.0 to 3.0 at a frequency of 10 Hz, a temperature of 100° C., and a stress of 2,000 Pa.

2. The toner according to claim 1, wherein the binder resin is manufactured using at least one catalyst selected from the group consisting of a tin (II) oxide and a tin compound having the following formula (1):
(RCOO)₂Sn (1)
wherein R represents an alkyl or alkenyl group having 5 to 19 carbon atoms.

3. The toner according to claim 2, wherein the binder resin contains the catalyst in an amount of from 0.2 to 1.0% by weight.

4. The toner according to claim 1, wherein the aromatic oxycarboxylic acid is a compound having following formula (1): 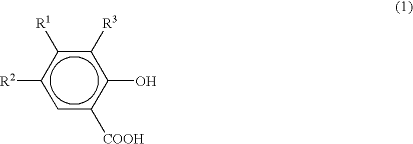
wherein each of R¹, R², and R³ independently represents a monovalent group, wherein R¹ may share bond connectivity with R² or R³ to form an aromatic ring or a condensed ring.

5. The toner according to claim 4, wherein the aromatic oxycarboxylic acid is a compound selected from the group consisting of compounds of formulae (2)-(9):

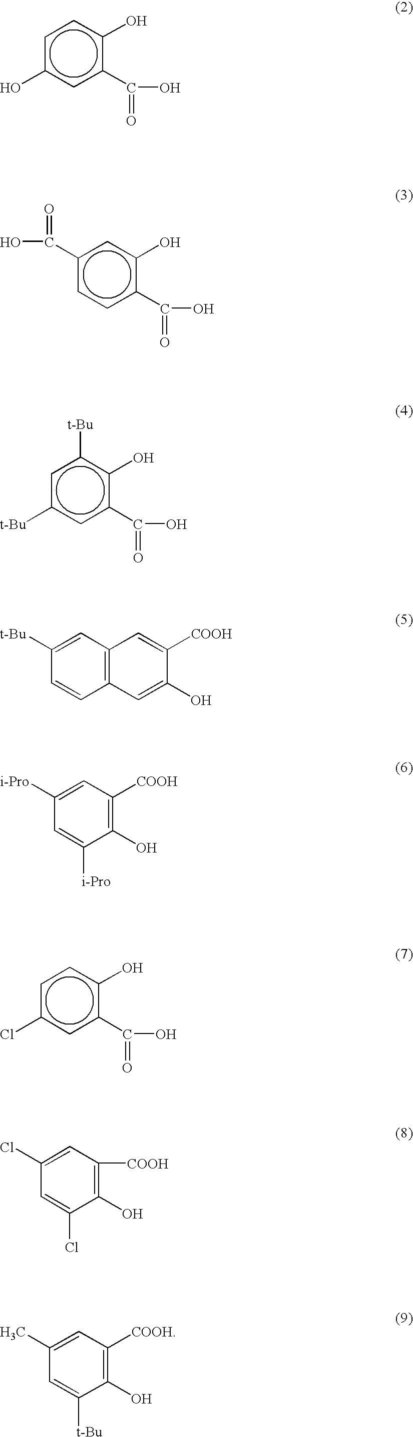

6. The toner according to claim 5, wherein the aromatic oxycarboxylic acid is 3,5-di-tertiary-butyl salicylic acid.

7. The toner according to claim 1, wherein the toner has a weight average particle diameter of from 3.0 to 5.0 μm measured by a Coulter method.

8. The toner according to claim 1, wherein THF-soluble components of the toner have a peak within a molecular weight range of from 2,500 to 6,000 in a chromatogram measured by GPC (gel permeation chromatography) using THF.

9. The toner according to claim 1, wherein the at least one of an aluminum compound and a zirconium compound of an aromatic oxycarboxylic acid is at least one zirconium compound having one of the following formulae (A) or at least one aluminum compound having one of the following formulae (B):

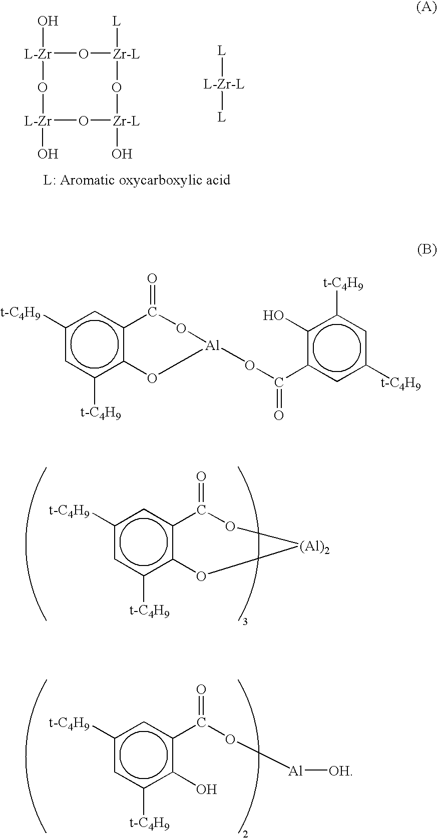

10. The toner according to claim 1, wherein the binder resin is (a) a polyester resin.

11. The toner according to claim 1, wherein the binder resin is (b) a hybrid resin comprising a polyester unit and a vinyl copolymer unit.

12. The toner according to claim 1, wherein the binder resin is (c) a mixture of a polyester resin and a hybrid resin.

13. An image forming method, comprising:
charging a charging target by externally applying a voltage to a charging member;
forming an electrostatic image on the charged charging target;
developing the electrostatic image with a toner to form a toner image;
transferring the toner image onto a transfer target by externally applying a voltage to a transfer member;
cleaning a surface of the charging target after the transferring; and
fixing the toner image on a recording medium by passing the recording medium having the unfixed toner image thereon through a nip formed between a heating member and a pressing member,
wherein the toner is the toner according to claim 1.

14. The image forming method according to claim 13, wherein both the heating member and the pressing member are rollers.

15. An image forming method, comprising:
charging a charging target by externally applying a voltage to a charging member;
forming an electrostatic image on the charged charging target;
developing the electrostatic image with a toner to form a toner image;
transferring the toner image onto a transfer target by externally applying a voltage to a transfer member;
cleaning a surface of the charging target after the transferring; and
fixing the toner image on a recording medium by bringing the recording medium having the unfixed toner image thereon into contact with an endless belt,
wherein the toner is the toner according to claim 1.

16. An image forming method, comprising:
charging a charging target by externally applying a voltage to a charging member;
forming an electrostatic image on the charged charging target;
developing the electrostatic image with a toner to form a toner image by a developing device containing a control blade and at least one of a developing roller and a developing sleeve;
transferring the toner image onto a transfer target by externally applying a voltage to a transfer member;
cleaning a surface of the charging target after the transferring; and
fixing the toner image on a recording medium by passing the recording medium having the unfixed toner image thereon through a nip formed between a heating member and a pressing member,
wherein the control blade forms a gap between the developing roller or the developing sleeve of from 0.1 to 0.5 mm, and
wherein the toner is the toner according to claim 1.

17. A process cartridge detachably attachable to an image forming apparatus, comprising:
a photoreceptor; and
a developing device containing a developer containing the toner according to claim 1.
